(19) United States
(12) Patent Application Publication
(10) Pub. No.: US 2019/0039932 A1
(43) Pub. Date: Feb. 7, 2019

(54) Process For Treating Wastewater

(71) Applicant: Novozymes A/S, Bsgsvaerd (DK)

(72) Inventor: Christopher Curtis Flannery, Salem, VA (US)

(73) Assignee: Novozymes A/S, Bagsvaerd (DK)

(21) Appl. No.: 16/056,257

(22) Filed: Aug. 6, 2018

Related U.S. Application Data
(60) Provisional application No. 62/541,926, filed on Aug. 7, 2017.

(51) Int. Cl. C02F 11/04; C02F 1/58; C02F 3/30; C02F 3/34

(52) U.S. Cl. CPC C02F 11/04; C02F 1/58; C02F 2101/105; C02F 3/308; C02F 3/342; C02F 3/302

(57) ABSTRACT

Methods are provided for reducing or eliminating the amount of exogenous carbon sources added to wastewater or sludge thereof by the addition of a hydrolytic enzyme to primary or secondary sludge of wastewater wherein said hydrolytic enzyme enhances the hydrolysis and subsequent fermentation of the sludge, thereby generating more carbon sources in situ

### FIELD OF THE INVENTION

The present invention relates to processes for treating wastewater, and more particularly to a biological process for treating wastewater.

### BACKGROUND

Wastewater treating processes usually include multiple treatment areas or zones which can be roughly broken down into: (1) a preliminary treatment area; (2) a primary treatment area; and (3) a secondary treatment area. Additional treatment areas and or sequences may exist on a site to site basis.

The wastewater treatment process begins with the preliminary treatment area. Preliminary treatment is concerned with removing grit and damaging debris, such as cans, bath towels, etc., from the untreated wastewater. This is usually a two-stage treatment process whereby the debris such as rags and cans are removed by screens and the grit and heavier inorganic solids settle out of the untreated wastewater as it passes through a velocity controlled zone. The damaging inorganic debris is thus removed by screening or settling while organic matter carried within the fluid stream passes on.

Following the preliminary treatment area, the wastewater is directed to a primary treatment area. The primary treatment area entails a physical process wherein a portion of the organics are removed by flotation or sedimentation. The organics removed include feces, food particles, grease, paper, etc. and are technically defined as suspended solids. Usually 40-80 percent of the suspended solids are removed as primary sludge in this primary stage.

The third treatment stage is called secondary treatment and is usually a biological treatment process where bacteria are utilized under controlled conditions to remove nutrients or non-settling suspended and soluble organics from the wastewater. These materials would result in an unacceptable biological oxygen demand (BOD) if left untreated. Typically, one mode of this process consists of a basin in which the wastewater (primary effluent) is mixed with a suspension of microorganisms (activated sludge). This mixture is then aerated to provide oxygen for the support of the microorganisms which may then adsorb, assimilate, and metabolize the excess biological oxygen demand in the wastewater. After sufficient retention time, the mixture is then introduced into a clarifier or settler into which the biomass separates as settled sludge or secondary sludge from the liquid. The partially purified water (secondary effluent) then overflows into a receiving stream.

There are three principal types of secondary treatment for effecting treatment of wastewater. The first type, known as a trickling filter or a fixed film system, allows the wastewater to trickle down through a bed of stone or plastic media whereby the organic material present in the wastewater is oxidized by the action of microorganisms attached to the stone or media. A similar concept is the rotating biological contactor (RBC) wherein the biology is attached to the media which rotates in the wastewater and purifies it in the manner of a trickling filter. The second method is a conventional activated sludge process in which the wastewater is fully aerated and agitated by either compressed air or mechanical means together with a portion of the biomass which has been returned from the clarifier or settler. The third process is an altered version of the activated sludge process and may be referred to as a semi-aerobic (anaerobic/oxic) process in which the first stage is typically anaerobic or anoxic and is followed by an oxic or aerobic stage. This anaerobic-oxic-anoxic process is very similar to the initial stages of the Phoredox process and the modified Bardenpho process, both well known in the wastewater treatment industry. Additionally, processes exist under the umbrella term of biological nutrient removal (or BNR) where wastewater flow and sludge return flows are alternated and/or repeated through anaerobic-anoxic-oxic zones or sequences. These additional processes are known as but not limited to: A/O, A2/O, Ludzack and Ettinger (LE), Modified Ludzack and Ettinger (MLE), Bio-Denitro, University of Cape Town Model (UCT), and the Virginia Initiative Plant (VIP).

Many wastewater facilities are now facing very stringent nitrogen and phosphorus control standards, and these control standards are expected to become stricter and more broadly applied in the near future. This is because there is a growing concern about the nitrate level of wastewater dumped into receiving streams. Removing phosphorus or nitrogen from wastewater can be difficult and include a high-cost process that requires the addition of additives such as metal salt and/or carbon source to a wastewater treatment process. For example, a carbon source, such as glycerol, methanol, or volatile fatty acids (VFA), may be added to the process in an anaerobic treatment zone and/or the anoxic treatment zone and/or aerobic treatment zone to assist with phosphorous or nitrogen removal. However, due to very large volume of wastewater treated, large amounts of carbon source must be added to effectively increase its concentration in the wastewater. Therefore, the addition of a carbon source to wastewater is demanding and significantly contributes to the expense of treating wastewater. Nitrogen and phosphate removal from wastewater has been attempted with a mixed microalgae and bacteria culture (Delgadillo-Mirquez et al, Biotechnology Reports, Volume 11, September 2016, pp. 18-26). However, microalgae are known to uncouple nutrient uptake from growth. They can continue to grow after nutrient exhaustion including phosphorus exhaustion. Additionally, cell rupture, releasing the intercellular phosphate content into the medium, may increase phosphate concentration.

In methods where the addition of an external carbon source is needed in wastewater treatment, a more economical and practical process is needed.

### BRIEF SUMMARY OF THE FIGURES

FIG. 1 illustrates the Relative Percent Increase in soluble fatty acids compared to the control for Example 8-1.

FIG. 2 illustrates the Relative Percent Increase in soluble fatty acids compared to the control for Example 8-2.

FIG. 3 illustrates the Relative Percent Increase in soluble fatty acids compared to the control for Example 8-3.

FIG. 4 illustrates the Relative Percent Increase in soluble fatty acids compared to the control for Example 8-4.

### SUMMARY OF THE INVENTION

The invention relates, at least in part, to a method of treating wastewater comprising the use of a hydrolytic enzyme characterized in that the hydrolytic enzyme generates a carbon source when contacted with primary or secondary sludge.

In one aspect, the present invention relates to a method for treating wastewater, comprising (a) directing the wastewater to and through a primary clarifier to separate organic compound-containing wastewater and primary sludge; (b) directing the organic compound-containing wastewater to an anaerobic treatment zone and/or an anoxic treatment zone and/or aerobic treatment zone; and (c) directing the wastewater through the anaerobic treatment zone and/or the anoxic treatment zone and/or aerobic treatment zone to a secondary clarifier to separate purified supernatant and secondary sludge; wherein the primary sludge and/or the secondary sludge is contacted with a hydrolytic enzyme, to produce a supernatant that includes carbon sources.

A further aspect of the invention is directed to an in situ carbon source generation for phosphorous and nitrogen removal in wastewater in a municipal or industrial wastewater treatment process, comprising the addition of a hydrolytic enzyme to primary or secondary sludge for the in situ carbon source generation.

A further aspect of the invention is directed to a method of increasing the carbon source in sludge water in a municipal or industrial wastewater process comprising the use of a hydrolytic enzyme wherein the hydrolytic enzyme is characterized in that the enzyme causes the in situ generation of carbon sources.

A further aspect of the invention is directed to method of reducing or eliminating the amount of exogenous carbon sources added to wastewater or sludge thereof by the addition of a hydrolytic enzyme to primary or secondary sludge of wastewater wherein said hydrolytic enzyme enhances the hydrolysis and subsequent fermentation of the sludge, thereby generating more carbon sources in situ.

In another aspect, the present invention relates to a method for producing a supernatant that includes carbon sources by wastewater, comprising a) directing the wastewater to and through a primary clarifier to separate organic compound-containing wastewater and primary sludge; (b) directing the organic compound-containing wastewater to an anaerobic treatment zone and/or an anoxic treatment zone and/or aerobic treatment zone; (c) directing the wastewater through the anaerobic treatment zone and/or the anoxic treatment zone and/or aerobic treatment zone to a secondary clarifier to separate purified supernatant and secondary sludge; and (d) fermenting primary sludge and/or secondary sludge to produce a supernatant that includes carbon sources; wherein the primary sludge and/or the secondary sludge is contacted with a hydrolytic enzyme.

In a further aspect, the present invention relates to a method for removing contaminants and nutrients such as BOD, phosphorus, and nitrogen from wastewater, comprising (a) directing the wastewater to and through a primary clarifier to separate organic compound-containing wastewater and primary sludge; (b) directing the organic compound-containing wastewater to an anaerobic treatment zone and/or an anoxic treatment zone and/or aerobic treatment zone; (c) directing the wastewater through the anaerobic treatment zone and/or the anoxic treatment zone and/or aerobic treatment zone to a secondary clarifier to separate purified supernatant and secondary sludge; wherein the primary sludge and/or the secondary sludge is contacted with a hydrolytic enzyme, to produce a supernatant that includes carbon sources.

### DETAILED DESCRIPTION OF THE INVENTION

In one aspect, the present invention relates to a method for treating wastewater, comprising (a) directing the wastewater to and through a primary clarifier to separate organic compound-containing wastewater and primary sludge; (b) directing the organic compound-containing wastewater to an anaerobic treatment zone and/or an anoxic treatment zone and/or aerobic treatment zone; and (c) directing the wastewater through the anaerobic treatment zone and/or the anoxic treatment zone and/or aerobic treatment zone to a secondary clarifier to separate purified supernatant and secondary sludge; wherein the primary sludge and/or the secondary sludge is contacted with a hydrolytic enzyme, to produce a supernatant that includes carbon sources.

In another aspect, the present invention relates to a method for producing a supernatant that includes carbon sources by wastewater, comprising a) directing the wastewater to and through a primary clarifier to separate organic compound-containing wastewater and primary sludge; (b) directing the organic compound-containing wastewater to an anaerobic treatment zone and/or an anoxic treatment zone and/or aerobic treatment zone; (c) directing the wastewater through the anaerobic treatment zone and/or the anoxic treatment zone and/or aerobic treatment zone to a secondary clarifier to separate purified supernatant and secondary sludge; and (d) fermenting primary sludge and/or secondary sludge to produce a supernatant that includes carbon sources; wherein the primary sludge and/or the secondary sludge is contacted with a hydrolytic enzyme.

In a further aspect, the present invention relates to a method for removing contaminants and nutrients such as BOD, phosphorus, and nitrogen from wastewater, comprising (a) directing the wastewater to and through a primary clarifier to separate organic compound-containing wastewater and primary sludge; (b) directing the organic compound-containing wastewater to an anaerobic treatment zone and/or an anoxic treatment zone and/or aerobic treatment zone; (c) directing the wastewater through the anaerobic treatment zone and/or the anoxic treatment zone and/or aerobic treatment zone to a secondary clarifier to separate purified supernatant and secondary sludge; wherein the primary sludge and/or the secondary sludge is contacted with a hydrolytic enzyme, to produce a supernatant that includes carbon sources.

For wastewater systems that have biological nutrient removal (BNR) processes, particularly enhanced biological phosphorus removal (EBPR), there is a need for carbon sources, including volatile fatty acids (VFAs), to be available. Some wastewater treatment plants have constructed or repurposed tanks for the purpose fermenting the primary and/or secondary sludge. This fermentation allows for natural conversion of sludge to VFAs by acetogenic bacteria. However, the systems normally do not produce enough, if any, VFAs in the primary stage of treatment, and therefore are required to dose in supplemental carbon sources (typically acetic acid for EBPR). In the present invention, hydrolytic enzymes enhance hydrolysis and subsequent fermentation of primary sludge, thereby generating more carbon sources. In one embodiment, the carbon sources generated in fermentation by addition of hydrolytic enzymes are in a sufficient amount so that the amount of carbon sources additionally supplemented to wastewater can be reduced or eliminated. In one embodiment, no supplemental carbon sources are required. The amount the carbon sources added is strictly dependent on the amount of nitrogen, phosphorus to be removed. In one embodiment, by addition of a hydrolytic enzyme, the amount of carbon sources in the supernatant from the fermentation of the primary sludge and/or the secondary sludge is increased by at least 5%, such as at least 10%, at least 20%, at least 30%, at least 40%, at least 50%, at least 60%, at least 70%, at least 80%, at least 90%, and at least 100%, at least 120%, at least 150%, at least 180%, at least 200% by mass, compared to that without contacting the primary sludge and/or the secondary sludge with the hydrolytic enzyme. In embodiments, carbon source additionally supplemented to the wastewater treatment process is reduced by 10-100%. In embodiments, carbon source additionally supplemented to the wastewater treatment process is reduced by 10%, 20%, 30%, 40%, 50%, 60%, 70%, 80%, 90%, or 100%. In embodiments, additionally supplemented carbon source is eliminated from the process, such that no carbon source is additionally supplemented to the treatment.

In one embodiment, the carbon sources can go into the anaerobic treatment zone and/or the anoxic treatment zone and/or aerobic treatment zone. In one embodiment, these VFAs are fed into an anaerobic/anoxic section of a treatment tank directly prior to an aeration basin.

Primary and secondary sludges contain a wide range of organic materials susceptible to hydrolytic enzymes including cellulose, proteins, lipids, sugars, starches etc, which come from partially digested foods (dietary fibers, etc.) and from toilet paper. According to the present invention, the hydrolytic enzyme can be contacted with the primary sludge in the primary clarifier, or a treatment zone used especially for fermentation, for example, a fermenter.

In one embodiment, the primary sludge can be retained in the primary clarifier and fermented in the primary clarifier, to produce a supernatant that includes more optimal carbon sources. As such, the hydrolytic enzyme is contacted with the primary sludge in the primary clarifier. In another embodiment, the primary sludge can be directed to a fermenter; and retained and fermented in the fermenter, to produce a supernatant that includes carbon sources. As such the hydrolytic enzyme is contacted with the primary sludge in the fermenter.

In one embodiment, the wastewater treatment of the present invention comprises a step of directing the primary sludge to a fermenter; a step of directing the secondary sludge to a fermenter; and a step of retaining and fermenting the primary sludge and the secondary sludge to produce a supernatant that includes carbon sources. In one embodiment, the sludge is a fresh sludge. The sludge is preferably 0-30 days old, more preferably 0-15 days old, more preferably 0-5 days old, more preferably 0-2 days, more preferably 0-24 hours old, most preferably 0-12 hours old.

In one embodiment, the biological wastewater treatment process further comprises a step of transferring the supernatant that includes carbon sources to the anaerobic treatment zone and/or an anoxic treatment zone and/or aerobic treatment zone to remove contaminants and nutrients such as BOD, phosphorus, and nitrogen.

In one embodiment, the biological wastewater treatment process further comprises a step of transferring the supernatant that includes the optimal carbon sources to both the anoxic and anaerobic treatment zones.

In a further embodiment, the wastewater through the anaerobic treatment zone and/or anoxic treatment zone is directed to an aerobic treatment zone, to remove contaminants and nutrients such as BOD, phosphorus, nitrogen.

Through fermentation process, a supernatant that includes optimal carbon sources is produced. In one embodiment, the fermentation in the wastewater treatment is carried out by naturally fermenting organisms in the sludge of the wastewater treatment process, or externally added exogenous fermenting organisms. In a further embodiment, the fermentation in the wastewater treatment is carried out by naturally fermenting organisms in the sludge of the wastewater treatment process, supplemented with externally added exogenous fermenting organisms. In a further embodiment, the fermentation is carried out by naturally fermenting organisms, without externally added exogenous fermenting organisms. As used herein, “a naturally fermenting organism” refers to a fermenting organism that originate or are grown naturally in the wastewater treatment process. The naturally fermenting organisms include a variety of biological components, including bacteria, fungi, protozoa, rotifers, etc. While both heterotrophic and autotrophic microorganisms may reside in the sludge, heterotrophic microorganisms typically predominate.

Heterotrophic microorganisms obtain energy from carbonaceous organic matter in plant influent wastewater for the synthesis of new cells. These microorganisms then release energy via the conversion of organic matter into compounds, such as carbon dioxide and water. Autotrophic microorganisms in activated sludge generally reduce oxidized carbon compounds, such as carbon dioxide, for cell growth. These microorganisms obtain their energy by oxidizing ammonia to nitrate, known as nitrification. As used herein, “exogenous” refers to organisms that originate or are grown outside the wastewater treatment process. Non-limiting examples of exogenous fermenting organisms include fermenting organisms other than those in the wastewater stream of interest, as well as fermenting organisms isolated from a wastewater treatment process and grown separately therefrom.

A specific group of heterotrophic bacteria classified as polyphosphate accumulating organisms (PAOs) are responsible for a large portion of phosphorous uptake. PAOs such as Tetrasphaera spp. and Candidatus Accumulibacter spp. perform the function of luxury phosphorous uptake when cycled through anaerobic and oxic treatment zones or cycles. These organisms typically require the addition of readily available carbon sources, preferably VFAs, to perform luxury phosphorus uptake.

Non-limiting examples of phosphorus suitable for removal or elimination from a wastewater stream in accordance with the present disclosure include phosphorus dissolved in wastewater including bioavailable phosphorus and phosphorus that is bioavailable after degradation by microbes in a wastewater treatment process. Non-limiting examples of bioavailable phosphorus includes ortho phosphorus such as PO₄³⁻, HPO₄²⁻, H₂PO₄⁻, H₃PO⁴. Non-limiting examples of phosphorus that is bioavailable after degradation by microbes in a wastewater treatment process inorganic condensed phosphorus, organic phosphorus, chemically bound phosphorus and reduced phosphorus. Non-limiting examples of inorganic condensed phosphorus include pyrophosphate, tripolyphosphate, trimetaphosphate, and poly-phosphate granules. Non-limiting example of organic phosphorus includes influent cell material such as ATP. Non-limiting example of chemically bound phosphorus includes precipitant phosphorus complexes, absorbed phosphorus, metal phosphates such as iron phosphates, aluminum phosphates, or calcium phosphates, or higher metal complexes. Non-limiting examples of reduced phosphorus include phosphorus with oxidation number greater than 5, phosphides (oxidation number −3), diphosphide (oxidation number −2), tetraphosphide (−0.5), elemental P (oxidation number 0), hypophosphite (oxidation number+1), and phosphite (oxidation number+3).

In one embodiment, the sludge is retained and fermented with fermentation time of 0.5 day to 15 days, preferably 1.0 days to 10 days; more preferably 1.0 days to 5 days; most preferably 1.5-3 days.

In the present invention, the wastewater treatment process provides an energy and cost efficient method for the removal or elimination of contaminants and nutrients such as BOD, phosphorus, and nitrogen from wastewater. Carbon addition to conventional wastewater treatment processes is problematic given wastewater treatment systems treat many millions of gallons (or tens of thousands of cubic meters) of wastewater, and the amount of carbon source (or other additives) required to increase carbon concentration by 1 mg/L to achieve better phosphorus removal is enormous and costly. Since many systems require vast quantities of carbon source and/or other additives, embodiments of the present disclosure require reduced amounts of externally added carbon source in comparison to amounts typically used in wastewater treatment systems. In embodiments of the present disclosure, the removal of contaminants and nutrients such as BOD, phosphorus, and nitrogen requires reduced amounts or no externally carbon source added to the process stream, as it produces more carbon sources in the process using hydrolytic enzymes to degrade the sludge before fermentation.

As stated, one aspect of the invention is directed to a method of treating wastewater comprising the use of a hydrolytic enzyme characterized in that the hydrolytic enzyme generates a carbon source when contacted with primary or secondary sludge.

According to the invention, the hydrolytic enzyme may be selected from the group consisting of a carbohydrase, such as an arabinanase, a cellulase, a beta-glucanase, a hemicellulase and a xylanase, a protease, an amylase, a lipase and combinations thereof. In one embodiment, the hydrolytic enzyme is selected from the group consisting of a xylanase, a cellulase, a hemicellulose, an amylase, and a beta-glucosidase, an alpha galactosidase, a beta-galactosidase and a galactanase, a protease, a lipase, and combinations thereof. In a further embodiment, the hydrolytic enzyme is selected from the group consisting of a combination of a xylanase, a cellulases, a beta-glucosidase; a 10R protease; a subtilisin; and a lipase. In an embodiment, the hydrolytic enzyme is a combination of a xylanase, one or more cellulases, and a beta-glucosidase, said combination comprising a GH10 xylanase, a Trichoderma reesei cellulase preparation. In an interesting embodiment, the hydrolytic enzyme is a combination comprising a Trichoderma reesei cellulase preparation containing Aspergillus fumigatus beta-glucosidase (as described in WO 2005/047499) and Thermoascus aurantiacus GH61A polypeptide (as described in WO 2005/074656).

In a preferred embodiment, the hydrolytic enzyme is selected from the group consisting of one or more cellulases, one or more lipases, one or more proteases, and one or more amylases and combinations thereof. The hydrolytic enzyme may be an enzyme mixture including a mixture of fermentation products such as an enzyme mixture comprising cellulases, amylases, proteases, and lipases optionally blended with facultative bacteria. In a further preferred embodiment, the hydrolytic enzyme is selected from the group consisting of one or more cellulases, one or more hemicellulases, one or more lipases, one or more endo-proteases, and one or more amylases and combinations thereof.

In a suitable embodiment of the invention, the hydrolytic enzyme comprises an Aspergillus aculeatus fermentation product, such as a wild type Aspergillus aculeatus fermentation product. Typically, in this embodiment, the Aspergillus aculeatus fermentation product is a multi-enzyme complex comprising carbohydrases, such as arabinanase, cellulase, beta-glucanase, hemicellulase and xylanase

In one embodiment, the hydrolytic enzyme comprises a blend of an Aspergillus fumigatus GH10 xylanase (WO 2006/078256) and Aspergillus fumigatus beta-xylosidase (WO 2011/057140). A related embodiment relates to a Trichoderma reesei cellulase preparation containing Aspergillus fumigatus cellobiohydrolase I (WO 2011/057140), Aspergillus fumigatus cellobiohydrolase II (WO 2011/057140), Aspergillus fumigatus beta-glucosidase variant (WO 2012/044915), and Penicillium sp. (emersonii) GH61 polypeptide (WO 2011/041397).

In an alternative embodiment, the hydrolytic enzyme comprises a mixture of crude fermentation product of cellulases from Trichoderma reesei and Cel45 endoglucanase from Thielavia terrestris.

A further alternative embodiment relates to an enzyme mixture that contains cellulase and beta-glucanase along with natural Trichoderma reesei Xylanase

In a further embodiment, the hydrolytic enzyme is a fermentation product comprising cellulases from Trichoderma reesei. In one embodiment, the hydrolytic enzyme comprises a carbohydrase, preferably the hydrolytic enzyme comprises a cellulase, especially a Trichoderma reesei cellulase, more preferably a combination of cellulase and hemicellulase. In a further embodiment, wherein hydrolytic enzyme comprises a cellulase, especially a Trichoderma reesei cellulase, more preferably a combination of cellulase and hemicellulase. And further comprises a protease, an amylase, and/or a lipase

In one embodiment, the hydrolytic enzyme comprises a protease, wherein the protease is a serine protease, preferably a 10R protease, typically from Nocardiopsis prasina.

In a further embodiment, the protease is a Subtilisin, such as a Subtilisin from Bacillus Ilicheniformis or from Bacillus clausii.

The hydrolytic enzyme may comprise an enzyme be selected from the group consisting of the serine protease from Nocardiopsis prasina, CAS #37259-58-8, the Subtilisin from Bacillus Ilicheniformis CAS #9014-01-1, Subtilisin from Bacillus clausii Cas #9014-01-1 E.C. 3.4.21.62, the alpha-amylase from Bacillus amyloliquefaciens CAS #9000-90-2 E.C. 3.2.1.1, the lipase from Thermomyces lanuginosus CAS #9001-62-1 E.C. 3.1.1.3, and the alpha amylase from Rhizomucor pusillus, such as a glucoamylase (glucan 1,4-alpha-glucosidase).

As can be seen from the Examples, the hydrolytic enzyme may suitably be selected from the group consisting of a cellulase and semi-cellulase preparation, an arabanase, cellulase, β-glucanase, hemicellulase, and xylanase preparation, an endo-protease preparation, an alpha-amylase preparation, a lipase preparation and a gluco-amylase preparation. Suitably, the hydrolytic enzyme is a commercial preparation, such as selected from the group consisting of Cellic® CTec2, Cellic® CTec3, Accellerase®, Spezyme®, Viscozyme®, Cytilase® CL, BG Max® 5505, Alcalase®, BAN® 480 LS, Lipex®, Savinase® and BPX® 10.5 C., such as Cellic® CTec2, Cellic® CTec3, Accellerase®, Spezyme®, and Cytilase® CL, BG Max® 5505, Alcalase®, BAN® 480 LS, Lipex®, and Savinase®. In one embodiment of the invention, the hydrolytic enzyme is a cellulase preparation, such as a commercial cellulase preparation, such as being selected from the group consisting of Cellic® CTec2, Cellic® CTec3, Accellerase®, Spezyme®, and Cytilase® CL.

An aspect of the invention is directed to a method of treating wastewater comprising the use of a hydrolytic enzyme characterized in that the hydrolytic enzyme generates a carbon source when contacted with primary or secondary sludge. The carbon source may be selected from the group consisting of one or more volatile fatty acids, single sugars and alcohols. Typically, the alcohol is selected from the group consisting of methanol, ethanol, propanol, and butanol.

Typically, the hydrolytic enzyme is contacted with primary or secondary sludge for 6 to 240 hours, such as 6 to 120 hours, typically 8 to 96 hours, such as 12 to 72 hours, more typically 18 to 72 hours.

In the present invention, a hydrolytic enzyme or hydrolase or is an enzyme that catalyzes the hydrolysis of a chemical bond. For example, an enzyme that catalyzed the following reaction is a hydrolase:

A-B+H₂O→A-OH+B—H

In an embodiment, the hydrolytic enzyme comprises a carbohydrase. As used herein, carbohydrase is an enzyme that catalyzes the breakdown of carbohydrates into simple sugars. Carbohydrase includes but not limited to, arabinanase, cellulase, beta-glucanase, hemicellulase, xylanase and amylase. In another embodiment, the hydrolytic enzyme comprises a cellulase, preferably a combination of cellulase and hemicellulase.

As used herein, “cellulase” or “cellulolytic enzyme” means one or more (e.g., several) enzymes that hydrolyze a cellulosic material. Such enzymes include endoglucanase(s), cellobiohydrolase(s), beta-glucosidase(s), or combinations thereof. The two basic approaches for measuring cellulolytic enzyme activity include: (1) measuring the total cellulolytic enzyme activity, and (2) measuring the individual cellulolytic enzyme activities (endoglucanases, cellobiohydrolases, and beta-glucosidases) as reviewed in Zhang et al., 2006, Biotechnology Advances 24: 452-481. Total cellulolytic enzyme activity can be measured using insoluble substrates, including Whatman No 1 filter paper, microcrystalline cellulose, bacterial cellulose, algal cellulose, cotton, pretreated lignocellulose, etc. The most common total cellulolytic activity assay is the filter paper assay using Whatman No 1 filter paper as the substrate. The assay was established by the International Union of Pure and Applied Chemistry (IUPAC) (Ghose, 1987, Pure Appl. Chem. 59: 257-68). The cellulases can be a bacterial polypeptide having cellulase activity. For example, each cellulase may be a Gram-positive bacterial polypeptide having cellulase activity, or a Gram-negative bacterial polypeptide having cellulase activity. Each cellulase may also be a fungal polypeptide have cellulase activity, e.g., a yeast cellualse or a filamentous fungal cellulase. In one embodiment, the cellulase is a Trichoderma reesei cellulase.

As used herein, “hemicellulase” or “hemicellulolytic enzyme” means one or more (e.g., several) enzymes that hydrolyze a hemicellulosic material. See, for example, Shallom and Shoham, 2003, Current Opinion In Microbiology 6(3): 219-228). Hemicellulases are key components in the degradation of plant biomass. Examples of hemicellulases include, but are not limited to, an acetylmannan esterase, an acetylxylan esterase, an arabinanase, an arabinofuranosidase, a coumaric acid esterase, a feruloyl esterase, a galactosidase, a glucuronidase, a glucuronoyl esterase, a mannanase, a mannosidase, a xylanase, and a xylosidase. The substrates for these enzymes, hemicelluloses, are a heterogeneous group of branched and linear polysaccharides that are bound via hydrogen bonds to the cellulose microfibrils in the plant cell wall, crosslinking them into a robust network. Hemicelluloses are also covalently attached to lignin, forming together with cellulose a highly complex structure. The variable structure and organization of hemicelluloses require the concerted action of many enzymes for its complete degradation. The catalytic modules of hemicellulases are either glycoside hydrolases (GHs) that hydrolyze glycosidic bonds, or carbohydrate esterases (CEs), which hydrolyze ester linkages of acetate or ferulic acid side groups. These catalytic modules, based on homology of their primary sequence, can be assigned into GH and CE families. Some families, with an overall similar fold, can be further grouped into clans, marked alphabetically (e.g., GH-A). A most informative and updated classification of these and other carbohydrate active enzymes is available in the Carbohydrate-Active Enzymes (CAZy) database. Hemicellulolytic enzyme activities can be measured according to Ghose and Bisaria, 1987, Pure & Appl. Chem. 59: 1739-1752, at a suitable temperature such as 40° C.-80° C., e.g., 50° C., 55° C., 60° C., 65° C., or 70° C., and a suitable pH such as 4-9, e.g., 5.0, 5.5, 6.0, 6.5, or 7.0.

In a further embodiment, the hydrolytic enzyme may be a preparation comprising further protease, an amylase, and/or a lipase.

In an embodiment, the hydrolytic enzyme is added to the primary sludge and/or secondary sludge in an amount of from 0.001% to 10%, preferably 0.005%-10%, more preferably 0.01%-8%, most preferably 0.05%-5% of the total solids (TS) of the sludge, by weight.

The present invention can accomplish BOD removal, biological phosphorus removal or nitrogen removal by reducing the cost and complexity of using exogenous carbon sources. It is economically efficient and compatible with existing facilities.

In the present invention, separate treatment zones can be used to remove contaminants and nutrients such as BOD, phosphorus, and nitrogen from plant influent wastewater. As used herein, plant influent wastewater is raw wastewater that has not yet been treated and therefore has not yet entered a wastewater treatment system, such as the wastewater treatment systems that are described herein. Once in the wastewater treatment system, or partially treated, the influent becomes mixed liquor as it flows through a treatment process.

In the present invention, wastewater is directed to a preliminary treatment zone which screens out, grinds up, and/or separates debris in the wastewater. Here, debris such as gravel, plastics, and other objects are removed to conserve space within the treatment processes and to protect pumping and other equipment from clogs, jams or wear and tear. Non-limiting examples of suitable screens include bar screens or a perforated screen placed in a channel. Preliminary treatment zone may also include a grit chamber suitable for the removal of debris such as sand, gravel, clay, and other similar materials. Aerated grit removal systems and cyclone degritters may also be employed.

After preliminary treatment, wastewater is directed to a primary clarifier. Here sedimentation occurs where the velocity of water is lowered below the suspension velocity causing the suspended particles to settle out of the water by gravity. Typical wastewater treatment plants include sedimentation in their treatment processes. However, sedimentation may not be necessary in water with low amounts of suspended solids. Primary clarifier may include different types of basins. Non-limiting examples of basins include rectangular basins which allow water to flow horizontally through a long tank, double-deck rectangular basins which are used to expand volume, while minimizing land area usage, square or circular sedimentation basins with horizontal flow, and/or solids-contact clarifiers, which combine coagulation, flocculation, and sedimentation within a single basin. Typical sedimentation basins suitable for use here have four zones including the inlet zone which controls the distribution and velocity of inflowing water, the settling zone in which the bulk of settling takes place, the outlet zone which controls the outflowing water, and the sludge zone in which the sludge collects. In one embodiment, the primary sludge is contacted with a hydrolytic enzyme in the primary clarifier. The primary sludge can be retained in the primary clarifier and fermented in the primary clarifier, to produce a supernatant that includes carbon sources. In such circumstance, the sludge retention time is higher than that for conventional wastewater treatment process. In another embodiment, the primary sludge can be directed to a treatment zone used especially for fermentation, for example, a fermenter. The primary sludge can be retained in the fermenter and fermented in fermenter, to produce a supernatant that includes carbon sources. As such the hydrolytic enzyme is contacted with the primary sludge in the fermenter. By an easy operational change, the present invention can produce more carbon sources needed for removing contaminants and nutrients such as BOD, phosphorus, and nitrogen.

After the wastewater is subjected to primary clarifier and the primary sludge has been sufficiently settled or removed, the wastewater flows into secondary treatment. In an embodiment, wastewater is subjected optionally to a first anaerobic treatment zone, such as an anaerobic basin. Here the wastewater is mixed with the contents of the anaerobic basin and may be referred to as a mixed liquor. In another embodiment, anaerobic basin is a deep basin with sufficient volume to permit sedimentation of solids, to digest retained sludge, and to anaerobically reduce some of the soluble organic substrate. Anaerobic basin can be made of material such as earth, concrete, steel or any other suitable material. Anaerobic basin is added downstream from the primary clarifier, and upstream to, or before an anoxic treatment zone (such as an anoxic basin) and aerobic treatment zone (such as an aerobic basin). In an embodiment, anaerobic basin is not aerated, or heated. Optionally anaerobic basin can be mixed. The depth of anaerobic basin is predetermined to reduce the effects of oxygen diffusion from the surface, allowing anaerobic conditions to predominate. In embodiments, anaerobic basin is used for treating wastewater including high strength organic wastewaters such as industrial or municipal wastewater and communities that have a significant organic load. Here, biochemical oxygen demand (BOD) removals greater than 50 percent are possible. In an embodiment, the retention time in the anaerobic basin is between 0.25 to 6 hours and a temperature of greater than 15 degrees C. The methods of the invention are suitably performed at temperatures ranging from 0 degrees C. to 40 degrees C., typically from 5 to 35 degrees C., preferably from 10 to 30 degrees C.

In an embodiment, the carbon source generated by fermenting or digesting sludges in the wastewater treatment process is transferred to the anaerobic basin to help the native or exogenous PAOs perform their phosphorous release phase. This phosphorous release step is critical for the PAOs to perform the following step of luxury uptake in an aerobic basin or zone. In the anaerobic step, a PAO will typically release one molecule of orthophosphate during the luxury uptake step, for the three molecules of orthophosphate the PAO will uptake during the aerobic step.

Wastewater leaves anaerobic basin and flows optionally into anoxic treatment zone, such as anoxic basin. Anoxic basin operates under anoxic conditions. In an embodiment, the wastewater process stream includes the anoxic basin to promote denitrification of the wastewater, where nitrate is converted to nitrogen gas. Heterotrophic bacteria in anoxic basin use the nitrate as an oxygen source under anoxic conditions to break down organic substances.

Under Anoxic Conditions:

Nitrates+Organics+Heterotrophic Bacteria=Nitrogen Gas, Oxygen and Alkalinity

In an embodiment, anoxic basin operates under any suitable conditions to promote anoxic conditions. Non-limiting examples include establishing an anoxic zone in an unaerated basin where the dissolved oxygen levels are kept below 1 mg/L or as close, without reaching 0 mg/L as possible. In an embodiment, oxygen levels are in the amount of 0.2 to 0.5 mg/L. The pH of the anoxic basin should be close to neutral (7.0) and preferably not drop below 6.5. In an embodiment, carbon source generated by fermenting or digesting sludges in the wastewater treatment process is transferred to the anoxic basin in the amount where at least 2.86 mg COD are required per mg of NO₃—N removed. In embodiments, the anoxic basin operates at conditions favorable to heterotrophic bacteria including, but not limited to temperatures maintained within the range of 5 to 48° C., or at least above 5° C. The pH of anoxic basin should range from 6.0 to 8.5, at least above 5.5.

Wastewater process stream leaves the anoxic basin, and typically flows into an aerobic treatment zone, such as an aerobic basin. In an embodiment, the aerobic basin operates under any suitable conditions to promote aerobic conditions. Non-limiting examples of aerobic conditions include injecting air or oxygen into a wastewater process stream or mixed liquor to promote the biological oxidation thereof. In an embodiment, surface aerators expose wastewater to air. In embodiments, the purpose of the basin is to biologically assist converting the soluble biodegradable organics in influent (or mixed liquor passing through the treatment) to a biomass which is able to settle as sludge. Bacteria present in the aerobic basin include those bacteria suitable in the degradation of organic impurities in an aerobic basin. Accordingly, in an embodiment, aerobic treatment processes take place in the presence of air and utilize those microorganisms such as aerobes, which use molecular/free oxygen to assimilate organic impurities i.e. convert them in to carbon dioxide, water and biomass. In an embodiment, the aerobic basin operates at conditions favorable to aerobes including, but not limited to temperatures maintained within the range of 5 to 45° C., or at least above 5° C. The pH of aerobic basin should range from 6 to 8.5, at least above 5.5. In an embodiment, carbon source generated by digesting sludges in the wastewater treatment process is transferred to the aerobic basin for luxury phosphorous uptake.

Wastewater leaves the aerobic basin and flows into a secondary clarifier. Any suitable secondary clarifier can be used suitable for solid/liquid separation. Suitable secondary clarifiers for use in accordance with the present disclosure separate and remove solids/biomass produced in biological process in a manner that suits process goals (rapid sludge removal, detention time, etc.). Secondary clarifier may also be used to thicken solids for recirculation and process reuse and/or store biomass as buffer to prevent process upsets. All the return activated (RAS) sludge is collected in the bottom of the secondary clarifier. RAS can be pumped back into the system (e.g., upstream), as well as sludge can be pumped to sludge processing. In an embodiment, to ensure enough bacteria are available to consume waste in wastewater, sludge is returned to the anaerobic basin from the secondary clarifier. The activated sludge will increase in quantity as it consumes more organic material in the wastewater process stream.

Wastewater leaves the secondary clarifier and flows optionally into tertiary treatment, disinfection and discharge. In embodiments, sludge leaves the tertiary treatment and flows or is pumped back into sludge processing.

In accordance with the present disclosure, carbon sources can be directed to a wastewater system at various points in the process stream or mixed liquor. For example, carbon source can be directed alone, or in combination with anaerobic tank, anoxic tank, aerobic tank, raw activated sludge stream, or side stream. Carbon sources include acetic acid, propionic acid, glycerol, glucose, molasses, high fructose corn syrup, methanol, high carbonaceous industrial waste and combinations thereof. Carbon sources are transferred to the process stream in an amount sufficient to maintain or nourish bacterial conditions therein. For example, carbon source can be added in an amount of 1 mg/L to 1000 mg/L of wastewater process stream, underflow or water separated from sludge. In embodiments, at least 3 or more mg/L carbon source per mg/L phosphorus to be removed is added in accordance with the present disclosure. In embodiments, at least 1 or more mg/L carbon source per mg/L phosphorus to be removed is added in accordance with the present disclosure. In embodiments, at least 3 or more mg/L carbon source per mg/L phosphorus to be removed is directed to the wastewater treatment process in accordance with the present disclosure. In one embodiment, the carbon sources generated in fermentation by addition of hydrolytic enzymes are in a sufficient amount so that the amount of carbon sources additionally supplemented to wastewater can be reduced or eliminated. In one embodiment, no supplemental carbon sources are required.

Embodiments of the present disclosure can be applied to a variety of known wastewater treatment plants, and many known configurations are possible. In one embodiment, secondary treatment can include combinations of basins that use, in sequence, an anaerobic basin, anoxic basin and aerobic basin. In another embodiment, secondary treatment can include combinations of basins other than the embodiments that use, in sequence, an anaerobic basin, anoxic basin and aerobic basin. Non-limiting examples of alternative wastewater treatment processes include those processes where secondary treatment only includes one or more anoxic and one or more aerobic basins, or only one or more anaerobic and one or more aerobic basins. Basins can be set up in a variety of ways known to one of ordinary skill in the art. In embodiments, only one or more aerobic basins are used in secondary treatment.

The removal of phosphorus in enhanced biological phosphorus removal (EBPR) systems requires a carbon sources, typically a soluble volatile fatty acids (sVFA). Specifically, Phophorus Accumulating Organisms (PAOs) take in these sVFAs under anaerobic conditions to produce energy so that they can accumulate ortho-phosphate under aerobic conditions. Influent wastewater often does not contain enough sVFAs, so it is frequently necessary to increase the sVFAs. This is usually done by adding acids, such as acetic acid. The present invention is directed to the use of enzymes to increase sVFAs by catalyzing hydrolysis and fermentation of the primary sludge. An aspect of the invention is directed to an in situ carbon source generation for phosphorous and nitrogen removal in wastewater in a municipal or industrial wastewater treatment process, comprising the addition of a hydrolytic enzyme to primary or secondary sludge for the in situ carbon source generation.

Alternatively defined, the invention is directed to a method of increasing the carbon source in sludge water in a municipal or industrial wastewater process comprising the use of a hydrolytic enzyme wherein the hydrolytic enzyme is characterized in that the enzyme causes the in situ generation of carbon sources, such as volatile fatty acids.

Further alternatively defined, the invention is directed to a method of reducing or eliminating the amount of exogenous carbon sources added to wastewater or sludge thereof by the addition of a hydrolytic enzyme to primary or secondary sludge of wastewater wherein said hydrolytic enzyme enhances the hydrolysis and subsequent fermentation of the sludge, thereby generating more carbon sources in situ.

An interesting further aspect of the invention is the in situ carbon source generation for phosphorus and/or nitrogen removal in wastewater in a municipal or industrial wastewater treatment process, comprising the addition of a hydrolytic enzyme to primary or secondary sludge for the in situ carbon source generation. The nitrogen in the wastewater is typically in the form of ammonium, nitrite (NO₂⁻) and nitrate (NO₃⁻), as well as nitrogen particulate. The phosphorus in the wastewater is typically in the form of PO₄³⁻.

The following non-limiting examples further illustrate compositions, methods, and treatments in accordance with the present disclosure. It should be noted that the disclosure is not limited to the specific details embodied in the examples.

### EXAMPLES

Methodology

Before setting up the trial, the primary sludge was analyzed for initial pH, total solids (TS), volatile solids (VS), chemical oxygen demand (COD), soluble COD (sCOD) (filtered with 0.22 pm), and soluble volatile fatty acids (sVFA) (filtered with 0.22 pm). Additionally, the COD of each enzyme sample was determined. Table 1 shows the COD and density of each enzyme; these values were used to calculate the initial COD of the samples and the desired dose in mL, respectively.

TABLE 1
Enzyme Characteristics

| | Density | COD | |
|---|---|---|---|
| | (g/mL) | (mg/L) | Description |
| Hydrolytic | 1.15 | 572,150 | A blend of an Aspergillus aculeatus |
| enzyme-1 | | | GH10 xylanase (WO 94/021785) and a |
| | | | Trichoderma reesei cellulase preparation |
| | | | containing Aspergillus fumigatus beta- |
| | | | glucosidase (WO 2005/047499) and |
| | | | Thermoascus aurantiacus GH61A |
| | | | polypeptide (WO 2005/074656) |
| | | | (commercially available as CTec2) |
| Hydrolytic | 1.21 | 453,510 | A wild type Aspergillus aculeatus |
| enzyme-2 | | | fermentation product, Multi-enzyme |
| | | | complex containing a wide range of |
| | | | carbohydrases, incl. arabinanase, |
| | | | cellulase, beta-glucanase, hemicellulose |
| | | | and xylanase |
| Hydrolytic | 1.07 | 232,500 | A fermentation product comprising |
| enzyme-3 | | | cellulases from Trichoderma reesei |
| | | | (ATCC 26921) |
| Hydrolytic | 1.15 | — | A blend of an Aspergillus fumigatus |
| enzyme-4 | | | GH10 xylanase (WO 2006/078256) and |
| | | | Aspergillus fumigatus beta-xylosidase |
| | | | (WO 2011/057140) with a Trichoderma |
| | | | reesei cellulase preparation containing |
| | | | Aspergillus fumigatus cellobiohydrolase I |
| | | | (WO 2011/057140), Aspergillus fumigatus |
| | | | cellobiohydrolase II (WO 2011/057140), |
| | | | Aspergillus fumigatus beta-glucosidase |
| | | | variant (WO 2012/044915), and |
| | | | Penicillium sp. (emersonii) |
| | | | GH61 polypeptide (WO 2011/041397) |
| Hydrolytic | 1.12 | — | A mixture of crude fermentation product |
| enzyme-5 | | | of cellulases from Trichoderma reesei |
| | | | and Cel45 endoglucanase from Thielavia |
| | | | terrestris |
| Hydrolytic | N/A | — | An enzyme mixture that includes |
| enzyme-6 | | | cellulases, amylases, proteases, and |
| | | | lipases blended with facultative bacteria |
| Hydrolytic | 1.16 | — | An enzyme mixture that contains rich |
| enzyme-7 | | | cellulase and beta-glucanase components |
| | | | along with natural Trichoderma reesei |
| | | | Xylanase |

### Example 1: Effect of Hydrolytic Enzyme on Fermentation of Primary Sludge for VFA

A number of 600 mL beakers were set up with 25% primary sludge and 75% DI water by volume. For each trial a control (without enzyme) was run as well as samples with a formulated enzyme product dose of approximately 1,500 ppm or a range of 52-270 ppm active enzyme protein (AEP) by volume. Each beaker was mixed at a slow rate with a magnetic stir bar for 30 minutes. The mixing was ceased and the samples were analyzed for pH and sVFA. The samples were covered with foil and allowed to settle for a period of time (24-96 hours). At this point the samples were mixed again for 5-10 minutes, just enough to get a homogenous sample, and analyzed again for COD, sCOD, sVFA and pH.

Experimental Set Up

Two trials were run to determine the effectiveness of hydrolytic enzymes on increasing VFAs coming from primary sludge. Trial 1 tested the enzymes hydrolytic enzyme-2 and hydrolytic enzyme-1, with two replicates each. Trial 2 tested the enzymes hydrolytic enzyme-2, hydrolytic enzyme-1, and hydrolytic enzyme-3, with four replicates each.

For Trial 1 the primary sludge was a discrete sample taken from the Roanoke Regional Water Pollution Control Plant (Roanoke, Va., USA). The sample represents the primary sludge as it is wasted to solids handling operations and is not a “core” sample including the bulk water which represents the primary effluent. The characteristics of the primary sludge were shown in Table 2. Six 600 mL beakers with 350 mL total volume were comprised of 88 mL sludge and 262 mL DI water. Two of the beakers were dosed with hydrolytic enzyme-1 at a concentration of 283 ppm AEP, and two of the beakers were dosed with hydrolytic enzyme-2 at a concentration of 58 ppm AEP. The set-up for this trial is seen in Table 3.

TABLE 2
Trial 1 Primary Sludge Characteristic

| | |
|---|---|
| COD | 44,415 |
| sCOD | 844 |
| VFA | N/A |
| pH | 5.77 |
| Density (g/mL) | 0.946 |

Average Values

| | |
|---|---|
| TS | 40,703 ppm |
| % TS per sludge | 4.1% |
| % VS per TS | 70% |
| % VS per sludge | 2.8% |

TABLE 3
Trial 1 Experimental Set-up

| | | | | | | | | Enzyme | Enzyme |
|---|---|---|---|---|---|---|---|---|---|
| | | | | | Enzyme | Enzyme | | Product | Product |
| | Total | Sludge | | | Product | Product | AEP Dose | Dose | Dose |
| | (mL) | (mL) | TS (g) | VS (g) | Dose (mg) | Dose (ppm) | (ppm) | (% TS) | (% VS) |
| Control | 350 | 88 | 3.4 | 2.4 | 0 | 0 | 0 | 0 | 0 |
| Hydrolytic | 350 | 88 | 3.4 | 2.4 | 551 | 1574 | 283 | 16.4% | 23.4% |
| enzyme-1 | | | | | | | | | |
| Hydrolytic | 350 | 88 | 3.4 | 2.4 | 579 | 1656 | 58 | 17.2% | 24.6% |
| enzyme-2 | | | | | | | | | |

For Trial 2 the primary sludge was another discrete sample taken from the Roanoke Regional Water Pollution Control Plant. The characteristics of the primary sludge were shown in Table 4. Sixteen 600 mL beakers with 400 mL total volume, comprised of 100 mL sludge and 300 mL DI water. Four of the beakers were dosed with hydrolytic enzyme-1 at a concentration of 298 ppm AEP; four of the beakers were dosed with hydrolytic enzyme-2 at a concentration of 61 ppm AEP; and four of the beakers were dosed with hydrolytic enzyme-3 at a concentration of 92 ppm AEP. The set-up for this trial is seen in Table 5.

TABLE 4
Trial 2 Primary Sludge Characteristics

| | |
|---|---|
| COD | 26,736 |
| sCOD | 853 |
| VFA | 667 |
| pH | 6.09 |
| Density (g/mL) | 0.995 |

Average Values

| | |
|---|---|
| TS | 22,458 ppm |
| % TS per sludge | 2.2% |
| % VS per TS | 67% |
| % VS per sludge | 1.5% |

TABLE 5
Trial 2 Experimental Set-up

| | | | | | | | | Enzyme | Enzyme |
|---|---|---|---|---|---|---|---|---|---|
| | | | | | Enzyme | Enzyme | | Product | Product |
| | Total | Sludge | | | Product | Product | AEP Dose | Dose | Dose |
| | (mL) | (mL) | TS (g) | VS (g) | Dose (mg) | Dose (ppm) | (ppm) | (% TS) | (% VS) |
| Control | 400 | 100 | 2.2 | 1.5 | 0 | 0 | 0 | 0 | 0 |
| Hydrolytic | 400 | 100 | 2.2 | 1.5 | 662 | 1,656 | 298 | 30% | 45% |
| enzyme-1 | | | | | | | | | |
| Hydrolytic | 400 | 100 | 2.2 | 1.5 | 697 | 1742 | 61 | 31% | 47% |
| enzyme-2 | | | | | | | | | |
| Hydrolytic | 400 | 100 | 2.2 | 1.5 | 616 | 1,541 | 92 | 28% | 42% |
| enzyme-3 | | | | | | | | | |

Results: Trial 1

After 68 hours, the greatest increase in VFA was seen with the hydrolytic enzyme-1, with a 267% increase. The hydrolytic enzyme-2 showed a 190% increases. Both should be compared to a 160% increase in the Control. Table 6 compares the VFA increases. Error bars (not included) showed that the differences between each sample were significant. The initial VFA was taken after the enzymes were dosed and thirty minutes of mixing had passed, which may have elevated the initial VFA for the samples with enzymes.

TABLE 6
Initial and Final sVFA (mg/L) for Trial 1

| | Initial | Final |
|---|---|---|
| Control | 237 | 616 |
| Hydrolytic enzyme-1 | 292 | 1071 |
| Hydrolytic enzyme-2 | 277 | 8001 |

Like the VFA results, the hydrolytic enzyme-1 had the greatest effect on pH with a final average pH of 4.4. The hydrolytic enzyme-2 final average pH was 5.3, and the control was 5.9. Table 7 displays the average initial and final pH.

TABLE 7
Initial and Final pH for Trial 1

| | Initial | Final |
|---|---|---|
| Control | 5.8 | 5.9 |
| Hydrolytic enzyme-1 | 5.5 | 4.4 |
| Hydrolytic enzyme-2 | 5.4 | 5.3 |

An initial value for sCOD and total COD for each beaker was calculated from the analyzed sCOD and total COD of the primary sludge and the enzymes. The initial and final sCOD and total COD were listed in Table 8. As expected, the total COD for the beakers did not change, as there was no carbon lost in the system. The soluble COD for all samples increased due to the insoluble COD converting to VFA and becoming soluble via the digestion process.

TABLE 8
Total COD and sCOD for Trial 1

| | | | sCOD (mg/L) | | |
|---|---|---|---|---|---|
| | Total COD (mg/L) | | | Final | |
| | Initial | Final | Initial | (meas- | % |
| | (calculated) | (measured) | (calculated) | ured) | Increase |
| Control | 10,503 | 12,228 | 200 | 544 | 158% |
| Control | 10,503 | 11,852 | 200 | 619 | 193% |
| Hydrolytic | 11,403 | 11,886 | 1100 | 1427 | 44% |
| enzyme-1 | | | | | |
| Hydrolytic | 11,403 | 12,075 | 1100 | 1323 | 33% |
| enzyme-1 | | | | | |
| Hydrolytic | 11,254 | 11,658 | 951 | 902 | 9% |
| enzyme-2 | | | | | |
| Hydrolytic | 11,254 | 11,344 | 951 | 1106 | 33% |
| enzyme-3 | | | | | |

Results: Trial 2

After 24 hours, the greatest increase in VFA was again seen with the hydrolytic enzyme-1, with a 185% increase. The hydrolytic enzyme-3 showed a 174% increase, and the hydrolytic enzyme-2 showed a 113% increase. These should be compared to 84% increase in the Control. Table 9 is a comparative graph of the VFA increases. Error bars were included on the graph and showed that the differences between each sample were significant. The initial VFA was taken after the enzymes were dosed and thirty minutes of mixing had passed, which may have elevated the initial VFA for the samples with enzymes.

TABLE 9
Initial and Final sVFA (mg/L) for Trial 2

| | Initial | Final |
|---|---|---|
| Control | 149 | 274 |
| Hydrolytic enzyme-1 | 217 | 619 |
| Hydrolytic enzyme-2 | 191 | 406 |
| Hydrolytic enzyme-3 | 179 | 491 |

The decrease in pH for Trial 2 followed the same trend as in Trial 1 where the samples with largest increase in VFA (hydrolytic enzyme-1) showed the greatest drop in pH. The samples with hydrolytic enzyme-1 had an average final pH of 4.5; the samples with hydrolytic enzyme-3 had an average final pH of 5.2; the samples with hydrolytic enzyme-2 had an average final pH of 4.45; and the control samples had an average final pH of 5.8. Table 10 listed the average initial and final pH.

TABLE 10
Initial and Final pH for Trial 1

| | Initial | Final |
|---|---|---|
| Control | 5.9 | 5.8 |
| Hydrolytic enzyme-1 | 5.8 | 4.5 |
| Hydrolytic enzyme-2 | 5.8 | 5.2 |
| Hydrolytic enzyme-3 | 5.7 | 4.9 |

The initial and final sCOD and total COD for Trial 2 were listed in Table 11. As expected, the total COD for the beakers did not change, as there was no carbon lost in the system. The soluble COD for all samples increased due to the insoluble COD converting to VFA and becoming soluble via the digestion process. However, in Trial 2, there was a smaller percent increase in sCOD for all samples with enzymes as compared to Trial 1.

TABLE 11
Total COD and s COD for Trial 2

| | Total COD (mg/L) | | sCOD (mg/L) | | |
|---|---|---|---|---|---|
| | | Final | | Final | |
| | Initial | (meas- | Initial | (meas- | |
| | (calculated) | ured) | (calculated) | ured) | % Increase |
| Control | 6,653 | 5,609 | 212 | 688 | 225% |
| Control | 6,653 | 5,275 | 212 | 625 | 195% |
| Control | 6,653 | 4,838 | 212 | 585 | 176% |
| Control | 6,653 | 5,305 | 212 | 589 | 178% |
| Hydrolytic | 7,601 | | 1160 | 2111 | 82% |
| enzyme-1 | | | | | |
| Hydrolytic | 7,601 | 5,696 | 1160 | 2185 | 88% |
| enzyme-1 | | | | | |
| Hydrolytic | 7,601 | 5,923 | 1160 | 2159 | 86% |
| enzyme-1 | | | | | |
| Hydrolytic | 7,601 | 6,002 | 1160 | 1947 | 68% |
| enzyme-1 | | | | | |
| Hydrolytic | 7,443 | 6,027 | 1002 | 1058 | 6% |
| enzyme-2 | | | | | |
| Hydrolytic | 7,443 | 6,058 | 1002 | 1144 | 14% |
| enzyme-2 | | | | | |
| Hydrolytic | 7,443 | 6,800 | 1002 | 1044 | 4% |
| enzyme-2 | | | | | |
| Hydrolytic | 7,443 | 5,564 | 1002 | 998 | 0% |
| enzyme-2 | | | | | |
| Hydrolytic | 7,011 | 5,846 | 571 | 1352 | 137% |
| enzyme-3 | | | | | |
| Hydrolytic | 7,011 | 5,089 | 571 | 1366 | 139% |
| enzyme-3 | | | | | |
| Hydrolytic | 7,011 | 5,274 | 571 | 1449 | 154% |
| enzyme-3 | | | | | |
| Hydrolytic | 7,011 | 6,895 | 571 | 1505 | 164% |
| enzyme-3 | | | | | |

Conclusions:

These two initial trials showed that enzyme addition could increase the sVFA being generated by digesting primary sludge. Hydrolytic enzyme-1 and Hydrolytic enzyme-3 showed the greatest increase compared to the Controls.

### Example 2: Study of Hydrolytic Enzyme-1 and Hydrolytic Enzyme-3 on Fermentation of Primary Sludge for VFA Generation

Methodology

A number of 600 mL beakers were set up with 25% primary sludge and 75% DI water by volume. For each trial a control was run as well as samples with an enzyme dose of approximately 1% TS and 5% TS by mass. Each beaker was mixed at a slow rate with a magnetic stir bar for 5 minutes. The mixing was ceased and the samples were analyzed for pH and sVFA. The samples were covered with foil and allowed to settle for 24 hours. At this point the samples were mixed again for 5-10 minutes, just enough to get a homogenous sample, and analyzed again for COD, sCOD, sVFA and pH.

Experimental Set Up

In Trial 3 the enzymes hydrolytic enzyme-1 and hydrolytic enzyme-3 were tested at two doses with two replicates each. In addition, deactivated enzymes were tested to determine the effect that the increased sCOD from the enzyme product had on the generation of VFAs. To deactivate the enzymes, a 10% solution of enzymes in DI water was held in an 80° C. hot water bath for 30 minutes. The samples with active enzymes were dosed from a 10% enzyme solution as well.

The primary sludge was a discrete sample taken from the Roanoke Regional Water Pollution Control Plant. The sample represents the primary sludge as it is wasted to solids handling operations and is not a “core” sample including the bulk water which represents the primary effluent. The characteristics of the primary sludge were shown in Table 12. Fourteen 600 mL beakers with 400 mL total volume were comprised of 100 mL sludge and 300 mL DI water. Four beakers were dosed with autoclaved hydrolytic enzyme-1 or hydrolytic enzyme-3 (two beakers each) at a concentration of approximately 5% gram enzyme product or 0.9% and 0.3% AEP per gram TS, respectively; two beakers each were dosed with hydrolytic enzyme-1 at 1% and 5% gram enzyme product or 0.2% and 0.9% gram AEP per gram TS, respectively; and with hydrolytic enzyme-3 at 1% and 5% enzyme product or 0.05% and 0.26% gram AEP per gram TS, respectively. The set-up for this trial is seen in Table 13.

TABLE 12
Trial 3 Primary Sludge Characteristic

| | |
|---|---|
| COD | 36,732 |
| sCOD | 1421 |
| VFA | 735 |
| pH | 5.74 |
| Density (g/mL) | 0.995 |

Average Values

| | |
|---|---|
| TS | 26,155 ppm |
| % TS per sludge | 2.6% |
| % VS per TS | 78% |
| % VS per sludge | 2.0% |

TABLE 13
Experimental Set-up

| | | | | | Enzyme | Enzyme | | |
|---|---|---|---|---|---|---|---|---|
| | | | | | Product | Product | Enzyme | |
| | Total | Sludge | | | Dose | Dose | Product Dose | AEP Dose |
| | (mL) | (mL) | TS (g) | VS (g) | (mg) | (mg/L) | (% TS, w/w) | (% TS w/w) |
| Control | 400 | 100 | 2.6 | 2.0 | 0 | 0 | 0 | 0 |
| Hydrolytic | 400 | 100 | 2.6 | 2.0 | 112* | 279* | 4.8% | 0.86% |
| enzyme-1 | | | | | | | | |
| (deactivated) | | | | | | | | |
| Hydrolytic | 400 | 100 | 2.6 | 2.0 | 111* | 278* | 4.3% | 0.26% |
| enzyme-3 | | | | | | | | |
| (deactivated) | | | | | | | | |
| Hydrolytic | 400 | 100 | 2.6 | 2.0 | 22 | 56 | 0.9% | 0.16% |
| enzyme-1—1% | | | | | | | | |
| Hydrolytic | 400 | 100 | 2.6 | 2.0 | 112 | 279 | 4.8% | 0.86% |
| enzyme-1—5% | | | | | | | | |
| Hydrolytic | 400 | 100 | 2.6 | 2.0 | 22 | 56 | 0.9% | 0.05% |
| enzyme-3—1% | | | | | | | | |
| Hydrolytic | 400 | 100 | 2.6 | 2.0 | 111 | 278 | 4.3% | 0.26% |
| enzyme-3—5% | | | | | | | | |

*Heat shocked enzymes to deactivate.

Results: Trial 3

After 24 hours, the greatest increase in VFA was seen with a 5% gram enzyme product per gram TS dose of hydrolytic enzyme-1. Table 14 is a comparative graph of the average initial and final VFA for each sample. Error bars were included on the graph and showed that the differences between each sample were significant. Because the initial VFA was taken after only 5 minute of mixing, the initial VFA for each sample was approximately equal. Table 14 also shows the percent increase of each sample. The control and both samples with deactivated enzymes showed an increase of 83-89% versus the samples with active enzymes where the VFA increase ranges from 98-178%. This gave confidence that the VFA generation was not due solely to the COD increase, but rather to the activity of the enzymes.

TABLE 14
Trial 3 Initial and Final sVFA (mg/L)

| | Initial | Final | % Increase |
|---|---|---|---|
| Control | 222 | 407 | 83 |
| Hydrolytic enzyme-1 (deactivated) | 228 | 432 | 89 |
| Hydrolytic enzyme-3 (deactivated) | 217 | 409 | 89 |
| Hydrolytic enzyme-1 - 1% | 225 | 468 | 108 |
| Hydrolytic enzyme-1 - 5% | 228 | 627 | 176 |
| Hydrolytic enzyme-3 - 1% | 221 | 437 | 98 |
| Hydrolytic enzyme-3 - 5% | 223 | 494 | 121 |

The decrease in pH for Trial 3 shows that the samples with largest increase in VFA (Hydrolytic enzyme-1-5%, Hydrolytic enzyme-3-5%) showed the greatest drop in pH. Table 15 displays the average initial and final pH of all samples. In comparing final pH values and percent increase in VFA of Trials 1-3, a negative correlation was between the two values. The linear relationship is defined as having a slope of −0.4947, and a y-intercept of 5.8014 (R²=0.8146).

TABLE 15
Trial 3 Initial and Final pH

| | Initial | Final |
|---|---|---|
| Control | 5.88 | 5.32 |
| Hydrolytic enzyme-1 (deactivated) | 5.76 | 5.14 |
| Hydrolytic enzyme-3 (deactivated) | 5.66 | 5.21 |
| Hydrolytic enzyme-1 - 1% | 5.75 | 5.11 |
| Hydrolytic enzyme-1 - 5% | 5.63 | 4.81 |
| Hydrolytic enzyme-3 - 1% | 5.78 | 5.22 |
| Hydrolytic enzyme-3 - 5% | 5.73 | 5.08 |

The initial and final sCOD and total COD for Trial 3 were listed in Table 16. As expected, the total COD for the beakers did not change, as there was no carbon lost in the system. The slight decrease may be due to the error in the test. The soluble COD for most samples increased, likely due to the insoluble COD converting to VFA and becoming soluble via the digestion process.

TABLE 16
Total COD and s COD for Trial 3

| | Total COD (mg/L) | | sCOD (mg/L) | | |
|---|---|---|---|---|---|
| | Initial | Final | Initial | Final | % |
| | (calculated) | (measured) | (calculated) | (measured) | Increase |
| Control | 9141 | 8546 | 354 | 783 | 121 |
| Control | 9141 | 8363 | 354 | 857 | 142 |
| Hydrolytic enzyme-1 | 9300 | 8955 | 513 | 918 | 79 |
| (deactivated) | | | | | |
| Hydrolytic enzyme-1 | 9300 | 8548 | 513 | 932 | 82 |
| (deactivated) | | | | | |
| Hydrolytic enzyme-3 | 9205 | 8287 | 418 | 932 | 123 |
| (deactivated) | | | | | |
| Hydrolytic enzyme-3 | 9205 | 7918 | 418 | 778 | 86 |
| (deactivated) | | | | | |
| Hydrolytic enzyme-1 - 1% | 9173 | 8698 | 386 | 944 | 145 |
| Hydrolytic enzyme-1 - 1% | 9173 | 8635 | 386 | 971 | 152 |
| Hydrolytic enzyme-1 - 5% | 9300 | 8605 | 513 | 1399 | 173 |
| Hydrolytic enzyme-1 - 5% | 9300 | 8551 | 513 | 1319 | 157 |
| Hydrolytic enzyme-3 - 1% | 9154 | 8205 | 367 | 869 | 137 |
| Hydrolytic enzyme-3 - 1% | 9154 | 8782 | 367 | 857 | 134 |
| Hydrolytic enzyme-3 - 5% | 9205 | 7916 | 418 | 971 | 132 |
| Hydrolytic enzyme-3 - 5% | 9205 | 7961 | 418 | 1041 | 149 |

Conclusions:

This trial compared an enzyme product dose of 1% and 5% TS for both hydrolytic enzyme-1 and hydrolytic enzyme-3. Hydrolytic enzyme-1 has a greater effect on increasing the sVFA being generated by digesting primary sludge. Additionally, deactivated enzyme product samples were run that showed the increase in VFA generation was due to enzyme activity, rather than increase COD from the product.

### Example 3: Study of Hydrolytic Enzyme-1, Hydrolytic Enzyme-4, Hydrolytic Enzyme-5, and Hydrolytic Enzyme-6 on Fermentation of Primary Sludge for VFA Generation

Methodology

A number of 600 mL beakers were set up with 10% primary sludge and 90% DI water by volume. Liquid enzyme product (hydrolytic enzyme-1, hydrolytic enzyme-4, hydrolytic enzyme-5) were dosed at approximately 5% TS (approximately 0.9%, 1.0%, and 0.8% AEP, respectively) by mass, and dry enzymes microbial blend (hydrolytic enzyme-6) was dosed at approximately 225 g hydrolytic enzyme-6 per 1000 g COD. All samples were compared to a control where no enzymes were dosed. Each beaker was mixed at a slow rate with a magnetic stir bar for 5 minutes. The mixing was ceased and the samples were analyzed for pH and sVFA. The samples were covered with aluminum foil and allowed to settle for 24 hours. At this point the samples were mixed again for 5-10 minutes, just enough to get a homogenous sample, and analyzed again for sVFA and pH.

Experimental Set Up

In the experiments, hydrolytic enzyme-1, hydrolytic enzyme-4, and hydrolytic enzyme-5 were tested at approximately 5% TS by weight for these liquid enzyme products, and for Hydrolytic enzyme-6 at 225 g product per 1000 g COD with two replicates each. In addition, deactivated Hydrolytic enzyme-6 was tested to determine the effect that the increased sCOD from the product had on the generation of VFAs. Hydrolytic enzyme-6 was deactivated by autoclave.

The primary sludge was a discrete sample taken from the Roanoke Regional Water Pollution Control Plant. The sample represents the primary sludge as it was wasted to solids handling operations and is not a “core” sample including the bulk water, which represents the primary effluent. Note, the primary sludge sample was stored in the cold room for 3 weeks prior to the experiments, and as a result fermentation of the sample had progressed as seen in the increased level of sVFA taken 3 weeks later as compared to that of the freshly taken sample. The characteristics of the primary sludge were shown in Table 17.

TABLE 17
Primary Sludge Characteristic

| | |
|---|---|
| sVFA | 735 |
| sVFA (3 weeks later) | 1555 |
| pH | 5.74 |
| Density (g/mL) | 0.995 |

Average Values (3 weeks later)

| | |
|---|---|
| TS | ppm |
| % TS per sludge | 2.5% |
| % VS per TS | 76% |
| % VS per sludge | 1.9% |

Twelve 600 mL beakers with 400 mL total volume were comprised of 40 mL sludge and 360 mL DI water. Two beakers each were dosed with Hydrolytic enzyme-1, Hydrolytic enzyme-4, and Hydrolytic enzyme-5 at 113 ppm (approximately 5% g enzyme product per g TS). Hydrolytic enzyme-6 and hydrolytic enzyme-6 autoclaved were dosed at 225 g per 1000 g COD, which resulted in an 810 ppm dose. The set-up for this trial is seen in Table 18.

TABLE 18
Experimental Set-up

| | | | | | Enzyme | Enzyme | | |
|---|---|---|---|---|---|---|---|---|
| | | | | | Product | Product | Enzyme | |
| | Total | Sludge | TS | VS | Dose | Dose | Product Dose | AEP |
| | (mL) | (mL) | (g) | (g) | (mg) | (mg/L) | (% TS, w/w) | (% TS, w/w) |
| Control | 400 | 40 | 0.98 | 0.75 | 0 | 0 | 0 | 0 |
| Hydrolytic | 400 | 40 | 0.98 | 0.75 | 45 | 113 | 4.6% | 0.83% |
| enzyme-1 | | | | | | | | |
| Hydrolytic | 400 | 40 | 0.98 | 0.75 | 45 | 113 | 4.6% | 0.94% |
| enzyme-4 | | | | | | | | |
| Hydrolytic | 400 | 40 | 0.98 | 0.75 | 45 | 113 | 4.6% | 0.74% |
| enzyme-5 | | | | | | | | |
| Hydrolytic | 400 | 40 | 0.98 | 0.75 | 324 | 810 | 33% | N/A |
| enzyme-6 | | | | | | | | |
| Hydrolytic | 400 | 40 | 0.98 | 0.75 | 324* | 810* | 33% | N/A |
| enzyme-6 | | | | | | | | |
| (autoclaved) | | | | | | | | |

*Autoclaved product

Results:

After 24 hours, the greatest increase in VFA was seen with the Hydrolytic enzyme-6 at 32% increase. Keeping in mind the autoclaved hydrolytic enzyme-6 (where both enzymes and bacteria were deactivated) showed a 16% increase in VFA indicating that part of the reason for a 32% increase in the hydrolytic enzyme-6 might be due to raw materials in the formulation, rather than the effect of the enzymes or the bacteria. The enzyme only products, showed similar percent increases that ranged from 21%-28%. Table 19 is a comparative table of the average initial and final VFA for each sample. Error bars (not shown) measured for the same data showed that the differences between each sample were significant. Because the initial VFA was taken after only 5 minute of mixing, the initial VFA for each sample was approximately equal. Table 19 also shows the percent increase of each sample. As compared to previous work, the percent increase for the samples was lower. This was likely due to the age of the sludge that resulted in VFA generation/fermentation occurring in the cold room.

TABLE 19
Trial 3 Initial and Final sVFA (mg/L)

| | Initial | Final | % Increase |
|---|---|---|---|
| Control | 201 | 183 | −9 |
| Hydrolytic enzyme-1 | 196 | 250 | 28 |
| Hydrolytic enzyme-4 | 197 | 237 | 21 |
| Hydrolytic enzyme-5 | 193 | 243 | 26 |
| Hydrolytic enzyme-6 | 195 | 257 | 32 |
| Hydrolytic enzyme-6 (autoclaved) | 191 | 221 | 16 |

Table 20 displays the average initial and final pH of all samples.

TABLE 20
Trial 3 Initial and Final pH

| | Initial | Final |
|---|---|---|
| Control | 5.69 | 5.70 |
| Hydrolytic enzyme-1 | 5.43 | 5.08 |
| Hydrolytic enzyme-4 | 5.40 | 5.25 |
| Hydrolytic enzyme-5 | 5.73 | 5.17 |
| Hydrolytic enzyme-6 | 5.68 | 5.54 |
| Hydrolytic enzyme-6 (autoclaved) | 5.62 | 5.65 |

Samples where 5% g hydrolytic enzyme-1 per g TS that were run on both sample and sample (3 weeks old) where 25% v/v sludge and 10% v/v sludge was used. Table 21 shows a comparison of these two samples. The last column shows a calculated value for % VFA increase per enzyme per sludge volume, which for these two samples were significantly similar.

TABLE 21
Hydrolytic enzyme-1 Comparison

| | | Enzyme | Enzyme | | % Increase per |
|---|---|---|---|---|---|
| | | Product | Product | % | ppm Enzyme |
| | Sludge | Dose | Dose | Increase | product per |
| | (g) | (ppm) | (% TS, w/w) | VFA | gram sludge |
| Hydrolytic | 100 | 279 | 4.3% | 176% | 61.0 |
| enzyme-1 | | | | | |
| Hydrolytic | 40 | 113 | 4.6% | 28% | 62.9 |
| enzyme-1 (3 | | | | | |
| weeks old) | | | | | |

Conclusions:

This trial compared a percent increase in VFA generated using primary sludge dosed with hydrolytic enzyme-1, hydrolytic enzyme-4, hydrolytic enzyme-5, and hydrolytic enzyme-6. The primary sludge used in this trial was approximately 3 weeks old, which had an effect on the initial VFA, and likely skewed the results as the sludge's capacity to generate VFAs was significantly lowered. However, all enzymes products showed 21-28% increase in VFAs and Hydrolytic enzyme-6 showed 32% increase.

### Example 4: Study of Hydrolytic Enzyme-1, and Hydrolytic Enzyme-4 on Fermentation of Primary Sludge for VFA Generation

Methodology

A number of 600 mL beakers were set up with 10% primary sludge and 90% DI water by volume. Enzyme products were dosed into the appropriate beakers. All samples were compared to a control where no enzymes were dosed. Each beaker was mixed at a slow rate with a magnetic stir bar for 5 minutes. The mixing was ceased and the samples were analyzed for pH and sVFA. The samples were covered with foil and allowed to settle for 24 hours. At this point the samples were mixed again for 5 minutes, just enough to get a homogenous sample, and analyzed again for sVFA and pH.

Experimental Set Up

The primary sludge was a discrete sample taken from the Roanoke Regional Water Pollution Control Plant. The sample represents the primary sludge as it is wasted to solids handling operations and is not a “core” sample including the bulk water, which represents the primary effluent. The characteristics of the primary sludge were shown in Table 22.

TABLE 22
Primary Sludge Characteristic

| | |
|---|---|
| sVFA | 1876 |
| TS | 30,055 ppm |
| % TS per sludge | 3.0% |
| % VS per TS | 83% |
| % VS per sludge | 2.5% |

Six 600 mL beakers with 400 mL total volume were comprised of 40 mL sludge and 360 mL DI water. Two beakers each were dosed with hydrolytic enzyme-1 and hydrolytic enzyme-4 at 63 ppm (approximately 2% g enzyme product per g TS). The set-up for this trial is seen in Table 23.

TABLE 23
Experimental Set-up

| | | | | | | | Enzyme | Enzyme |
|---|---|---|---|---|---|---|---|---|
| | | | | | Enzyme | Enzyme | Dose | Dose |
| | Total | Sludge | TS | VS | Dose | Dose | (% TS, | (% VS, |
| | (mL) | (mL) | (g) | (g) | (mg) | (mg/L) | w/w) | w/w) |
| Control | 400 | 40 | 1.2 | 1.0 | 0 | 0 | 0 | 0 |
| Hydrolytic | 400 | 40 | 1.2 | 1.0 | 25 | 63 | 2.1% | 2.5% |
| enzyme-1 | | | | | | | | |
| Hydrolytic | 400 | 40 | 1.2 | 1.0 | 25 | 63 | 2.1% | 2.5% |
| enzyme-4 | | | | | | | | |

*Autoclaved product to deactivate.

Results:

After 24 hours the enzyme products, showed similar percent increases of 37-38% increase compared to the control, which had a percent increase in VFA of only 2%. Table 24 is a comparative table of the average initial and final VFA for each sample. Because the initial VFA was taken after only 5 minute of mixing, the initial VFA for each sample was approximately equal. Table 24 also shows the percent increase of each sample.

TABLE 24
Trial 4 Initial and Final sVFA (mg/L)

| | Initial | Final | % Increase |
|---|---|---|---|
| Control | 228 | 232 | 2% |
| Hydrolytic enzyme-1 | 224 | 309 | 38% |
| Hydrolytic enzyme-4 | 221 | 303 | 37% |

Table 25 displays the average initial and final pH of all samples.

TABLE 25
Trial 4 Initial and Final pH

| | Initial | Final |
|---|---|---|
| Control | 5.32 | 5.47 |
| Hydrolytic enzyme-1 | 5.12 | 4.93 |
| Hydrolytic enzyme-4 | 5.06 | 4.92 |

Conclusions:

This trial compared a percent increase in VFA generated using primary sludge dosed with hydrolytic enzyme-1, and hydrolytic enzyme-4. The two enzyme products (hydrolytic enzyme-1 & hydrolytic enzyme-4) showed 37-38% increase as compared to the control, which showed 2% increase.

### Example 5: Study of Hydrolytic Enzyme-4, Hydrolytic Enzyme-6, and Hydrolytic Enzyme-6 Enzymes on Fermentation of Primary Sludge for VFA Generation

Methodology

A number of 600 mL beakers were set up with 10% primary sludge and 90% DI water by volume. Enzymes/product were dosed into the appropriate beakers. All samples were compared to a control where no enzymes/product were dosed. Each beaker was mixed at a slow rate with a magnetic stir bar for 5 minutes. The mixing was ceased and the samples were analyzed for pH and sVFA. The samples were covered with foil and allowed to settle for 24 hours. At this point the samples were mixed again for 5 minutes, just enough to get a homogenous sample, and analyzed again for sVFA and pH.

Experimental Set Up

The primary sludge was a discrete sample taken from the Roanoke Regional Water Pollution Control Plant. The sample represents the primary sludge as it is wasted to solids handling operations and is not a “core” sample including the bulk water, which represents the primary effluent. The characteristics of the primary sludge, which were analyzed next day were shown in Table 26. The primary sludge sat in the cold room for approximately 6 days before the trial was run. This storage time may have resulted in fermentation of the sample as seen in a comparison of initial VFA levels of the individual samples in Example 4 versus Example 5, which used the sample primary sludge.

TABLE 26
Primary Sludge Characteristic

| | |
|---|---|
| sVFA | 1876 |
| TS | 30,055 ppm |
| % TS per sludge | 3.0% |
| % VS per TS | 83% |
| % VS per sludge | 2.5% |

Ten 600 mL beakers with 400 mL total volume were comprised of 40 mL sludge and 360 mL DI water. Two beakers each were dosed with hydrolytic enzyme-4 at 63 ppm (approximately 2% g enzyme product per g TS). Hydrolytic enzyme-6 and hydrolytic enzyme-6 autoclaved were dosed at a cost-comparable level, which is approximately 0.386% TS by mass. The hydrolytic enzyme-6 (enzyme-only) samples were dosed at 0.20% TS by mass. The experimental set-up is seen in Table 27.

TABLE 27
Experimental Set-up

| | | | | | Enzyme | Enzyme | | |
|---|---|---|---|---|---|---|---|---|
| | | | | | Product | Product | Enzyme | |
| | Total | Sludge | TS | VS | Dose | Dose | Product Dose | AEP |
| | (mL) | (mL) | (g) | (g) | (mg) | (mg/L) | (% TS, w/w) | (% TS, w/w) |
| Control | 400 | 40 | 1.2 | 1.0 | 0 | 0 | 0 | 0 |
| Hydrolytic | 400 | 40 | 1.2 | 1.0 | 25 | 63 | 2.1% | 0.43% |
| enzyme-4 | | | | | | | | |
| Hydrolytic | 400 | 40 | 1.2 | 1.0 | 4.4 | 11 | 0.37% | N/A |
| enzyme-6 | | | | | | | | |
| Hydrolytic | 400 | 40 | 1.2 | 1.0 | 4.4 | 11 | 0.37% | N/A |
| enzyme-6 | | | | | | | | |
| (autoclaved) | | | | | | | | |
| Hydrolytic | 400 | 40 | 1.2 | 1.0 | 2.4 | 6 | 0.20% | N/A |
| enzyme-6 | | | | | | | | |
| (enzymes | | | | | | | | |
| only) | | | | | | | | |

*Autoclaved product to deactivate

Results:

After 24 hours, the greatest increase in VFA was seen with the hydrolytic enzyme-4 at a 23% increase. The hydrolytic enzyme-6 samples, both the fully formulated and the autoclaved samples performed similar to the control, which showed an insignificant change in VFA levels. The hydrolytic enzyme-6 enzyme-only formulation showed an increase of 7%, which was significant compared to the control, but only slightly.

Table 28 is a comparative table of the average initial and final VFA for each sample. Because the initial VFA was taken after only 5 minute of mixing, the initial VFA for each sample was approximately equal. Table 28 also shows the percent increase of each sample.

TABLE 28
Trial 5 Initial and Final sVFA (mg/L)

| | Initial | Final | % Increase |
|---|---|---|---|
| Control | 268 | 263 | −2 |
| Hydrolytic enzyme-4 | 269 | 330 | 23 |
| Hydrolytic enzyme-6 | 265 | 261 | −2 |
| Hydrolytic enzyme-6 (autoclaved) | 263 | 265 | 1 |
| Hydrolytic enzyme-6 (enzymes only) | 259 | 278 | 7 |

Table 29 displays the average initial and final pH of all samples.

TABLE 29
Trial 5 Initial and Final pH

| | Initial | Final |
|---|---|---|
| Control | 4.89 | 5.32 |
| Hydrolytic enzyme-4 | 4.94 | 4.93 |
| Hydrolytic enzyme-6 | 4.95 | 5.37 |
| Hydrolytic enzyme-6 (autoclaved) | 5.03 | 5.26 |
| Hydrolytic enzyme-6 (enzymes only) | 5.07 | 5.25 |

Conclusions:

This trial compared a percent increase in VFA generated using primary sludge dosed with hydrolytic enzyme-4, hydrolytic enzyme-6, hydrolytic enzyme-6 autoclaved, and an enzyme-only version of hydrolytic enzyme-6. All versions of hydrolytic enzyme-6 showed significantly less VFA generation as compared to the hydrolytic enzyme-4.

### Example 6: Dosing Curve for Hydrolytic Enzyme-4 and Effect of Varying TS Levels on Fermentation of Primary Sludge for sVFA Generation

Methodology

A number of 600 mL beakers were set up with primary sludge diluted with DI water to a total volume of 400 mL. Enzymes products were dosed into the appropriate beakers. All samples were compared to a control where no enzymes/product were dosed. Each beaker was mixed at a slow rate with a magnetic stir bar for 5 minutes. The mixing was ceased and the samples were analyzed for sVFA. The samples were covered with foil and allowed to settle for 24 hours. At this point the samples were mixed again for 5 minutes, just enough to get a homogenous sample, and analyzed again for sVFA.

Experimental Set Up

The primary sludge was a discrete sample taken from the Roanoke Regional Water Pollution Control Plant. The sample represents the primary sludge as it is wasted to solids handling operations and is not a “core” sample including the bulk water, which represents the primary effluent. The characteristics of the primary sludge, which were analyzed were shown in Table 29. Trial 7 was started on the same day as it was collected and Trial 8 was started one month after it was collected.

TABLE 29
Primary Sludge Characteristic

| | |
|---|---|
| sVFA | 823 |
| TS | 22,311 ppm |
| % TS per sludge | 2.2% |
| % VS per TS | 83.7% |
| % VS per sludge | 1.9% |

For Trial 7, twelve 600 mL beakers with 400 mL total volume were comprised of 40 mL sludge and 360 mL DI water. Two beakers each were dosed with hydrolytic enzyme-4 at various levels based on TS (% enzyme product dose=g enzyme per g TS). The approximate values of 0.5%-4.0% were based on an assumed TS value in the influent to begin the trial prior to all primary sludge characteristics were analyzed. Once the actual % TS of the primary sludge was determined, the actual % enzyme dose was calculated. The experimental set-up for Trial 7 is shown in Table 30.

TABLE 30
Experimental Set-up for Trial 7

| | | | | | Enzyme | Enzyme | Enzyme | |
|---|---|---|---|---|---|---|---|---|
| | | | | | Product | Product | Product | |
| | Total | Sludge | | | Dose | Dose | Dose | AEP Dose |
| | (mL) | (mL) | TS (g) | VS (g) | (mg) | (mg/L) | (% TS, w/w) | (% TS, w/w) |
| Control | 400 | 40 | 0.89 | 0.74 | 0 | 0 | 0 | 0 |
| 0.5% | 400 | 40 | 0.89 | 0.74 | 6 | 15 | 0.7% | 0.14% |
| Hydrolytic | | | | | | | | |
| enzyme-4 | | | | | | | | |
| 1.0% | 400 | 40 | 0.89 | 0.74 | 12 | 30 | 1.4% | 0.28% |
| Hydrolytic | | | | | | | | |
| enzyme-4 | | | | | | | | |
| 2.0% | 400 | 40 | 0.89 | 0.74 | 24 | 60 | 2.7% | 0.55% |
| Hydrolytic | | | | | | | | |
| enzyme-4 | | | | | | | | |
| 3.0% | 400 | 40 | 0.89 | 0.74 | 36 | 90 | 4.0% | 0.81% |
| Hydrolytic | | | | | | | | |
| enzyme-4 | | | | | | | | |
| 4.0% | 400 | 40 | 0.89 | 0.74 | 48 | 120 | 5.4% | 1.1% |
| Hydrolytic | | | | | | | | |
| enzyme-4 | | | | | | | | |

For Trial 8, eight 600 mL beakers with 400 mL total volume were comprised of various sludge volumes from 20, 40, 60, 80 mL with a constant enzyme dose, of hydrolytic enzyme-4, to gram TS for all samples (2.0%=gram enzyme product per gram TS or 0.41% AEP gram per gram TS). The experimental set-up for Trial 8 is shown in Table 31.

TABLE 31
Experimental Set-up for Trial 8

| | | | | | | | Enzyme |
|---|---|---|---|---|---|---|---|
| | | | | | Enzyme | Enzyme | Product |
| | | | | | Product | Product | Dose |
| | Total | Sludge | | | Dose | Dose | (% TS, |
| | (mL) | (mL) | TS (g) | VS (g) | (mg) | (mg/L) | w/w) |
| 5% | 400 | 20 | 0.44 | 0.37 | 8.9 | 22.2 | 2.0% |
| Sludge | | | | | | | |
| 10% | 400 | 40 | 0.89 | 0.74 | 17.8 | 44.4 | 2.0% |
| sludge | | | | | | | |
| 15% | 400 | 60 | 1.33 | 1.123 | 26.7 | 66.6 | 2.0% |
| sludge | | | | | | | |
| 20% | 400 | 80 | 1.78 | 1.49 | 35.5 | 88.8 | 2.0% |
| sludge | | | | | | | |

Results: Trial 7

After 24 hours, the higher the enzyme dose, the greater the increase in sVFA. Table 31 showed the trends for sVFA production. Table 31 is a comparative table of the average initial and final sVFA for each sample. Because the initial sVFA was taken after only 5 minute of mixing, the initial sVFA for each sample was approximately equal. Table 31 also shows the percent increase of each sample.

TABLE 31
Trial 7 Initial and Final sVFA (mg/L)

| | Initial | Final | % Increase |
|---|---|---|---|
| Control | 90 | 164 | 82 |
| 0.5% | 92 | 168 | 83 |
| 1.0% | 86 | 184 | 114 |
| 2.0% | 89 | 192 | 115 |
| 3.0% | 90 | 210 | 133 |
| 4.0% | 86 | 214 | 148 |

A linear relationship with dose and % increase was calculated from the results in Trial 7 and found a relationship where the slope is 0.4627 and the y-intercept is 0.0301 (R²=0.9442). This showed the total increase in sVFA (grams) per gram enzyme dosed.

Results: Trial 8

After 24 hours, the greatest increase in sVFA was seen in the sample with the largest volume of sludge. Table 32 is a comparative table of the average initial and final sVFA for each sample. The initial sVFA for each sample were not equal due to the increase in sludge being added. The higher the volume of sludge, the higher the initial sVFA. Therefore, the total difference between initial and final sVFA (rather than the percent increase in sVFA) is also shown in Table 32.

TABLE 32
Trial 8 Initial and Final sVFA (mg/L)

| | Initial | Final | Net Increase |
|---|---|---|---|
| 5% Sludge | 77 | 99 | 22 |
| 10% Sludge | 111 | 194 | 83 |
| 15% Sludge | 152 | 291 | 139 |
| 20% Sludge | 195 | 388 | 193 |

A linear relationship with gram sludge and net increase (gram of sVFA) was calculated from the results in Trial 8 and found a relationship where the slope is 0.0414 when the y-intercept is forced to zero (R²=0.9554). This showed the total increase in sVFA (grams) per gram solid.

As the available TS increases, so does the generation of sVFA.

Conclusions:

Trial 7 compared the percent increase in sVFA generated using primary sludge dosed with various amounts of hydrolytic enzyme-4, from 0.5% to 4.0% (gram enzyme product per gram TS). As enzyme dose increases, sVFA generated also increases linearly.

Trial 8 showed the effect of that the grams of TS available (or sludge volume) has on sVFA generation at a constant enzyme dose. As available sludge increases, sVFA generated also increases.

### Example 7: Study of Hydrolytic Enzyme-1, Hydrolytic Enzyme-5, and Hydrolytic Enzyme-7 on Fermentation of Primary Sludge from Pepper's Ferry Wastewater Treatment Plant for sVFA Generation

Methodology

A number of 600 mL beakers were set up with primary sludge diluted with DI water to a total volume of 400 mL. Enzymes/product were dosed into the appropriate beakers. All samples were compared to a control where no enzymes/product were dosed. Each beaker was mixed at a slow rate with a magnetic stir bar for 5 minutes. The mixing was ceased and the samples are analyzed for sVFA. The samples were covered with foil and allowed to settle for 24 hours. At this point the samples were mixed again for 5 minutes, just enough to get a homogenous sample, and analyzed again for sVFA.

Experimental Set Up

The primary sludge was a discrete sample taken from the Pepper's Ferry WWTP (Pepper's Ferry Wastewater Treatment Plant, Radford, Va., USA). The sample represents the primary sludge as it is wasted to solids handling operations and is not a “core” sample including the bulk water, which represents the primary effluent. The characteristics of the primary sludge, which were analyzed were shown in Table 33. The experiment was started on the same day as it was collected.

TABLE 33
Primary Sludge Characteristics

| sVFA | 212 mg/L |
|---|---|
| TS | 43,596 mg/L |
| % TS per sludge | 4.4% |
| % VS per TS | 70.2% |
| % VS per sludge | 3.1% |

Eight 600 mL beakers with 400 mL total volume were comprised of 40 mL sludge and 360 mL DI water. Two beakers each were dosed with hydrolytic enzyme-1, hydrolytic enzyme-7, and hydrolytic enzyme-5 at approximately samples 2.0% gram enzyme product (0.2%, 0.18% and 0.09% gram AEP, respectively) per gram TS. The approximate value of 2.0% was based on an assumed TS value in the influent in order to begin the trial prior to all primary sludge characteristics were analyzed. Once the actual % TS of the primary sludge was determined, the actual enzyme product dose was calculated. The experimental set-up is shown in Table 34.

TABLE 34
Experimental Set-up

| | | | | | Enzyme | Enzyme | | |
|---|---|---|---|---|---|---|---|---|
| | | | | | Product | Product | Enzyme | |
| | Total | Sludge | | | Dose | Dose | Product Dose | AEP Dose |
| | (mL) | (mL) | TS (g) | VS (g) | (mg) | (mg/L) | (% TS, w/w) | (% TS, w/w) |
| Control | 400 | 40 | 1.74 | 1.22 | 0 | 0 | 0 | 0 |
| Hydrolytic | 400 | 40 | 1.74 | 1.22 | 20 | 49 | 1.12% | 0.2% |
| enzyme-1 | | | | | | | | |
| Hydrolytic | 400 | 40 | 1.74 | 1.22 | 20 | 49 | 1.12% | 0.18% |
| enzyme-5 | | | | | | | | |
| Hydrolytic | 400 | 40 | 1.74 | 1.22 | 20 | 49 | 1.12% | 0.09% |
| enzyme-7 | | | | | | | | |

Results:

After 24 hours, the greatest increase in VFA was seen with the hydrolytic enzyme-5 at a 282% increase, followed by hydrolytic enzyme-1 at a 244% increase. Table 35 shows the trends for sVFA production. Table 35 is a comparative table of the average initial and final sVFA for each sample. Because the initial sVFA was taken after only 5 minutes of mixing, the initial sVFA for each sample was approximately equal. Table 35 also shows the percent increase of each sample.

TABLE 35
Trial 7 Initial and Final sVFA (mg/L)

| | Initial | Final | % Increase |
|---|---|---|---|
| Control | 59 | 120 | 104 |
| Hydrolytic enzyme-1 | 50 | 173 | 244 |
| Hydrolytic enzyme-5 | 54 | 205 | 282 |
| Hydrolytic enzyme-7 | 51 | 157 | 207 |

Conclusions:

There was an increase in VFA for Pepper's Ferry primary sludge treated with enzymes versus a control, thus this gaining validation for this enzyme application. hydrolytic enzyme-5 (which had only been trialed previously on three-week-old sludge) had the greatest increase in VFAs as compared to the control, followed by hydrolytic enzyme-1 and hydrolytic enzyme-7.

It will be understood that various modifications may be made to the embodiments disclosed herein. Therefore, the above description should not be construed as limiting, but merely as exemplifications of embodiments. Those skilled in art will envision other modifications within the scope and spirit of the claims appended hereto. Moreover, terms should not be interpreted as implying any particular order among or between various steps herein disclosed unless and except when the order of individual steps is explicitly described.

### Example 8: Enzymes for sVFA Production

Methodology

To test to determine which enzymes facilitate greater sVFA generation during primary sludge fermentation, a simple beaker trial was run. Table 36 shows the density (from the Product Data Sheet) of commercially available enzymes CTec 2, BG Max 5505, Alcalase 2.5L, BAN 480 LS, Lipex 100L, Lipolase 100L, Savinase 16L, and BPX 10.5 C, which was used to calculate the dose in mL, the active enzyme protein (AEP), stated activity, and a brief description of the enzyme. Before setting up the trial, the primary sludge was analyzed for initial TS and VS. Eight 600 mL beakers are set up with primary sludge diluted with DI water to a total volume of 400 mL. Enzyme products are dosed into the appropriate beakers. All samples were compared to a control where no enzyme products were dosed. Each beaker is mixed at a slow rate with a magnetic stir bar for 5 minutes. The mixing was ceased and the samples were analyzed for sVFA, sCOD, COD, and pH. The samples were covered with foil and allowed to settle for 24 hours. At this point the samples were mixed again for 5 minutes, just enough to get a homogenous sample, and analyzed again for sVFA, sCOD, COD, and pH. All soluble analyses were performed on 0.45 pm filtered samples.

TABLE 36
Enzyme Characteristics

| | | | Density | | | |
|---|---|---|---|---|---|---|
| | | Description | (g/mL) | AEP | Stated Activity | |
| Hydrolytic Enzyme | CTec 2 | Cellulase and semi- | 1.15 | 18% | 1000 | BHU-2/g |
| #1 | | cellulase | | | | |
| Hydrolytic Enzyme | BG Max 5505 | Endo-protease | 1.16 | 5.8% | 75000 | PROT/g |
| #8 | | | | | | |
| Hydrolytic Enzyme | Alcalase 2.5L | Endo-protease | 1.08 | 4.8% | 2.5 | AU-A/g |
| #9 | | | | | | |
| Hydrolytic Enzyme | BAN 480 LS | Alpha-amylase | 1.25 | 2.6% | 480 | KNU-B/g |
| #10 | | | | | | |
| Hydrolytic Enzyme | Lipex 100L | Lipase | 1.15 | 1.9% | 100 | KLU/g |
| #11 | | | | | | |
| Hydrolytic Enzyme | Lipolase 100L | Lipase | 1.15 | 1.9% | 100 | KLU/g |
| #12 | | | | | | |
| Hydrolytic Enzyme | Savinase 16L | Endo-protease | 1.16 | 4.5% | 16 | KNPU-S/g |
| #13 | | | | | | |
| Hydrolytic Enzyme | BPX 10.5 C | Alpha-amylase/ | 1.14 | 3.04% | 55.2 | FAU-F/g |
| #14 | | Gluco-amylase | | 11.38% | 580 | AGU/g |

Experimental Set Up

The primary sludge used in Example 8-1 was a sample taken from the Winchester WWTP on May 22, 2018. The characteristics of the primary sludge (48-hour sludge) are shown in Table 37.

TABLE 37
Winchester Primary Sludge Characteristics

| | |
|---|---|
| % TS per sludge | 5.88% |
| % VS per TS | 78.88% |
| % VS per sludge | 4.64% |

The primary sludge used in Example 8-2 and Example 8-3 was a sample taken from the Roanoke WWTP. The characteristics of the primary sludge are shown in Table 38. Example 8-2 was 3-hour sludge. Example 8-3 was 48-hour sludge.

TABLE 38
Roanoke Primary Sludge Characteristics

| | |
|---|---|
| % TS per sludge | 4.25% |
| % VS per TS | 64.91% |
| % VS per sludge | 2.76% |

The primary sludge used in Example 8-4 was a sample taken from the Roanoke WWTP. The characteristics of the primary sludge, are shown in Table 39. Example 8-4 was 24 hour sludge.

TABLE 39
Roanoke Primary Sludge Characteristics

| | |
|---|---|
| % TS per sludge | 4.25% |
| % VS per TS | 64.91% |
| % VS per sludge | 2.76% |

For each experiment, eight 600 mL beakers with 400 mL total volume were comprised of 100 mL sludge and 300 mL DI water. Two beakers each were dosed with Hydrolytic Enzyme #1 and Hydrolytic Enzyme #8 and #9, that differed by trial, at approximately 2.0% gram enzyme per gram TS, while 2 beakers were not dosed and acted as controls. For Example 8-2 and Example 8-4, the approximate value of 2.0% was first based on an assumed TS value in the influent in order to begin the trial prior to some primary sludge characteristics that were analyzed. Once the actual % TS of the primary sludge was determined, the actual enzyme dose was calculated. For Example 8-2, the actual dose came out to be 1.2%, and for Example 8-4, the actual dose came out to be 3.01%. The experimental set-up for Example 8-1, Example 8-2, Example 8-3 and Example 8-4 are shown in Tables 40, 41, 42 and 43, respectively.

TABLE 40
Experimental Set-up for Example 8-1

| | | | | | Enzyme | Enzyme | Enzyme | Enzyme |
|---|---|---|---|---|---|---|---|---|
| | Total | Sludge | TS | VS | Dose | Dose | Dose | Dose |
| | (mL) | (mL) | (g) | (g) | (mg) | (mg/L) | (% TS, w/w) | (% VS, w/w) |
| Control | 400 | 100 | 5.88 | 4.64 | 0 | 0 | 0 | 0 |
| Hydrolytic | 400 | 100 | 5.88 | 4.64 | 118 | 295 | 2.00% | 2.54% |
| Enzyme #1 | | | | | | | | |
| Hydrolytic | 400 | 100 | 5.88 | 4.64 | 118 | 295 | 2.00% | 2.54% |
| Enzyme #8 | | | | | | | | |
| Hydrolytic | 400 | 100 | 5.88 | 4.64 | 118 | 295 | 2.00% | 2.54% |
| Enzyme #9 | | | | | | | | |

TABLE 41
Experimental Set-up for Example 8-2

| | | | | | Enzyme | Enzyme | Enzyme | Enzyme |
|---|---|---|---|---|---|---|---|---|
| | Total | Sludge | TS | VS | Dose | Dose | Dose | Dose |
| | (mL) | (mL) | (g) | (g) | (mg) | (mg/L) | (% TS, w/w) | (% VS, w/w) |
| Control | 400 | 100 | 4.25 | 2.76 | 0 | 0 | 0 | 0 |
| Hydrolytic | 400 | 100 | 4.25 | 2.76 | 49 | 122.5 | 1.20% | 1.79% |
| Enzyme #1 | | | | | | | | |
| H. Enzyme | 400 | 100 | 4.25 | 2.76 | 50 | 125 | 1.20% | 1.81% |
| #10 | | | | | | | | |
| H. Enzyme | 400 | 100 | 4.25 | 2.76 | 49 | 122.5 | 1.20% | 1.79% |
| #11 | | | | | | | | |

TABLE 42
Experimental Set-up for Example 8-3

| | | | | | Enzyme | Enzyme | Enzyme | Enzyme |
|---|---|---|---|---|---|---|---|---|
| | Total | Sludge | TS | VS | Dose | Dose | Dose | Dose |
| | (mL) | (mL) | (g) | (g) | (mg) | (mg/L) | (% TS, w/w) | (% VS, w/w) |
| Control | 400 | 100 | 4.25 | 2.76 | 0 | 0 | 0 | 0 |
| Hydrolytic | 400 | 100 | 4.25 | 2.76 | 85 | 212.5 | 2.00% | 3.08% |
| Enzyme #1 | | | | | | | | |
| Hydrolytic | 400 | 100 | 4.25 | 2.76 | 85 | 212.5 | 2.00% | 3.08% |
| Enzyme | | | | | | | | |
| #12 | | | | | | | | |
| Hydrolytic | 400 | 100 | 4.25 | 2.76 | 85 | 212.5 | 2.00% | 3.08% |
| Enzyme | | | | | | | | |
| #13 | | | | | | | | |

TABLE 43
Experimental Set-up for Example 8-4

| | | | | | Enzyme | Enzyme | Enzyme | Enzyme |
|---|---|---|---|---|---|---|---|---|
| | Total | Sludge | TS | VS | Dose | Dose | Dose | Dose |
| | (mL) | (mL) | (g) | (g) | (mg) | (mg/L) | (% TS, w/w) | (% VS, w/w) |
| Control | 400 | 100 | 3.90 | 2.97 | 0 | 0 | 0 | 0 |
| Hydrolytic | 400 | 100 | 3.90 | 2.97 | 118 | 295 | 3.01% | 3.95% |
| Enzyme #1 | | | | | | | | |
| Hydrolytic | 400 | 100 | 3.90 | 2.97 | 118 | 295 | 3.01% | 3.95% |
| Enzyme | | | | | | | | |
| #14 | | | | | | | | |
| Hydrolytic | 400 | 100 | 3.90 | 2.97 | 118 | 295 | 3.01% | 3.95% |
| Enzyme | | | | | | | | |
| #13 | | | | | | | | |

Results Example 8-1:

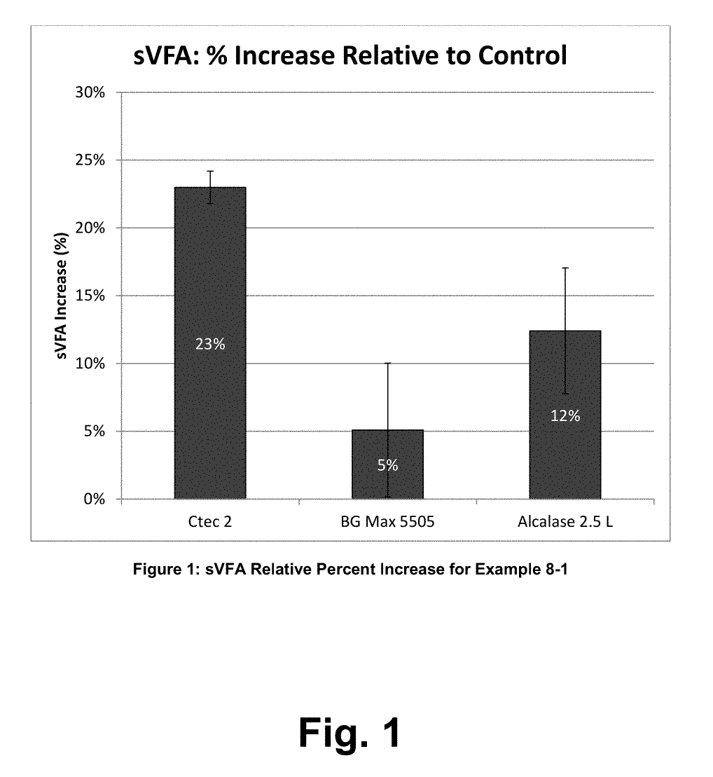

After 24 hours, the greatest increase in VFA was seen with the Hydrolytic Enzyme #1 at a 48% increase, followed by Hydrolytic Enzyme #9 at a 38% increase. Because the initial sVFA was taken after only 5 minutes of mixing, the initial sVFA for each sample was approximately equal. FIG. 1 shows the percent increase relative to the control.

Results Example 8-2:

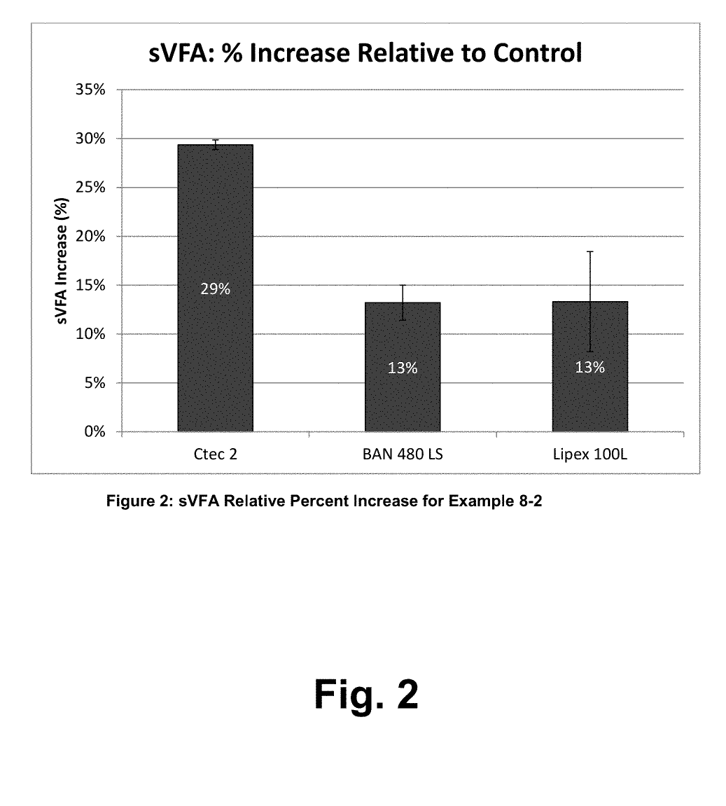

After 24 hours, the greatest increase in VFA was seen with Hydrolytic Enzyme #1 at a 139% increase, followed by Hydrolytic Enzyme #10 and Hydrolytic Enzyme #11 both at a 123% increase. Because the initial sVFA was taken after only 5 minutes of mixing, the initial sVFA for each sample was approximately equal. FIG. 2 shows the percent increase relative to the control.

Results Example 8-3:

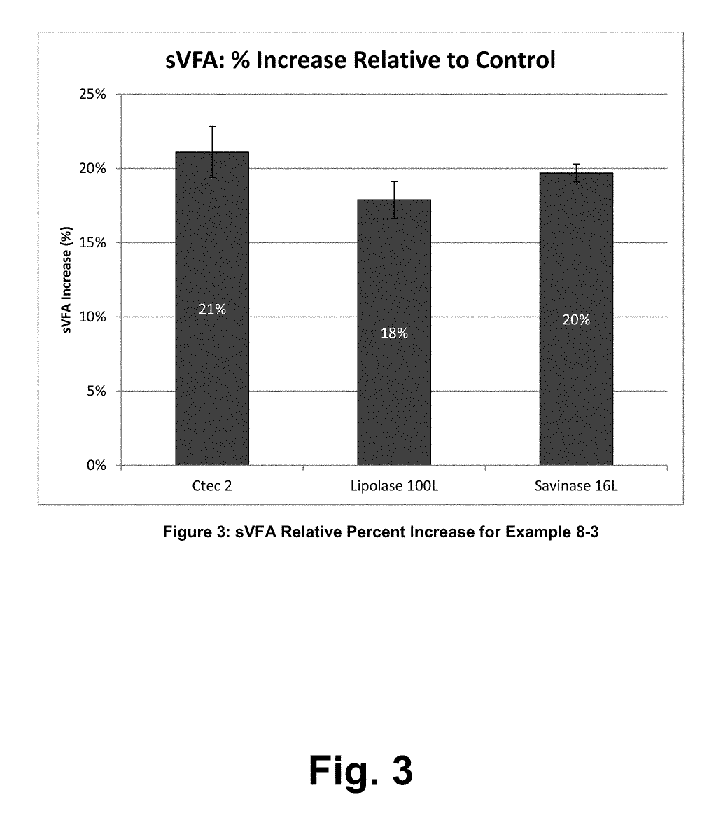

After 24 hours, the greatest increase in VFA was seen with Hydrolytic Enzyme #1 at a 69% increase, followed closely by Hydrolytic Enzyme #13 at a 68% increase. Even though this was the same primary sludge tested in 8-2, the sVFA increase was smaller because the primary sludge was older and had already began fermenting at this point in time. Because the initial sVFA was taken after only 5 minutes of mixing, the initial sVFA for each sample was approximately equal. FIG. 3 shows the percent increase relative to the control.

Results Example 8-4:

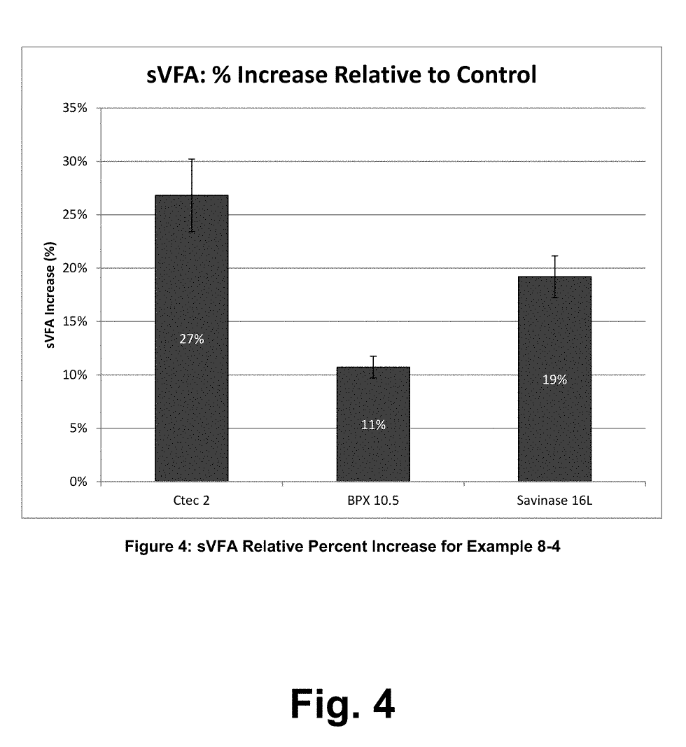

After 24 hours, the greatest increase in VFA was seen with Hydrolytic Enzyme #1 at a 36% increase, followed closely by Hydrolytic Enzyme #13 at a 28% increase. Because the initial sVFA was taken after only 5 minutes of mixing, the initial sVFA for each sample was approximately equal. FIG. 4 shows the percent increase relative to the control.

Conclusions of Example 8:

Example 8 showed that at least cellulases, lipases, proteases, and amylases generate an increase in sVFAs during primary sludge fermentation compared to controls. Overall, cellulases and proteases performed the best out of all the types of enzymes tested.

What is claimed is:

1. A method of treating wastewater comprising the use of a hydrolytic enzyme characterized in that the hydrolytic enzyme generates a carbon source when contacted with primary or secondary sludge.

2. An in situ carbon source generation for phosphorous and nitrogen removal in wastewater in a municipal or industrial wastewater treatment process, comprising the addition of a hydrolytic enzyme to primary or secondary sludge for the in situ carbon source generation.

3. A method of increasing the carbon source in sludge water in a municipal or industrial wastewater process comprising the use of a hydrolytic enzyme wherein the hydrolytic enzyme is characterized in that the enzyme causes the in situ generation of carbon sources.

4. A method of reducing or eliminating the amount of exogenous carbon sources added to wastewater or sludge thereof by the addition of a hydrolytic enzyme to primary or secondary sludge of wastewater wherein said hydrolytic enzyme enhances the hydrolysis and subsequent fermentation of the sludge, thereby generating more carbon sources in situ.

5. A method for treating wastewater, comprising
(a) directing the wastewater to and through a primary clarifier to separate organic compound-containing wastewater and primary sludge;
(b) directing the organic compound-containing wastewater to an anaerobic treatment zone and/or an anoxic treatment zone and/or aerobic treatment zone; and
(c) directing the wastewater through the anaerobic treatment zone and/or the anoxic treatment zone and/or aerobic treatment zone to a secondary clarifier to separate purified supernatant and secondary sludge;
wherein the primary sludge and/or the secondary sludge is contacted with a hydrolytic enzyme, to produce a supernatant that includes carbon sources.

6. The method of claim 5, comprising
a step of retaining and fermenting the primary sludge in the primary clarifier to produce a supernatant that includes carbon sources;
wherein the hydrolytic enzyme is contacted with the primary sludge in the primary clarifier.

7. The method of any of claims 5 to 6, comprising
a step of directing the primary sludge to a fermenter; and
a step of retaining and fermenting the primary sludge in the fermenter to produce a supernatant that includes carbon sources;
wherein the hydrolytic enzyme is contacted with the primary sludge in the fermenter.

8. The method of any of claims 5 to 7, comprising
a step of directing the primary sludge to a fermenter;
a step of directing the secondary sludge to a fermenter; and
a step of retaining and fermenting the primary sludge and the secondary sludge to produce a supernatant that includes carbon sources.

9. The method of any of claims 5 to 8, further comprising
a step of transferring the supernatant that includes carbon sources to the anaerobic treatment zone and/or an anoxic treatment zone and/or aerobic treatment zone to remove contaminants and nutrients such as BOD, phosphorus, and nitrogen.

10. The method of any of claims 5 to 9, further comprising
a step of transferring the supernatant that includes carbon sources to both the anoxic and anaerobic treatment zones.

11. The method of any of claims 5 to 10, wherein the wastewater through the anaerobic treatment zone and/or anoxic treatment zone is directed to an aerobic treatment zone, to remove contaminants and nutrients such as BOD, phosphorus, nitrogen.

12. A method for producing a supernatant that includes carbon sources by wastewater, comprising
a) directing the wastewater to and through a primary clarifier to separate organic compound-containing wastewater and primary sludge;
(b) directing the organic compound-containing wastewater to an anaerobic treatment zone and/or an anoxic treatment zone and/or aerobic treatment zone;
(c) directing the wastewater through the anaerobic treatment zone and/or the anoxic treatment zone and/or aerobic treatment zone to a secondary clarifier to separate purified supernatant and secondary sludge; and
(d) fermenting primary sludge and/or secondary sludge to produce a supernatant that includes carbon sources;
wherein the primary sludge and/or the secondary sludge is contacted with a hydrolytic enzyme.

13. A method for removing contaminants and nutrients such as BOD, phosphorus, and nitrogen from wastewater, comprising
(a) directing the wastewater to and through a primary clarifier to separate organic compound-containing wastewater and primary sludge;
(b) directing the organic compound-containing wastewater to an anaerobic treatment zone and/or an anoxic treatment zone and/or aerobic treatment zone;
(c) directing the wastewater through the anaerobic treatment zone and/or the anoxic treatment zone and/or aerobic treatment zone to a secondary clarifier to separate purified supernatant and secondary sludge;
wherein the primary sludge and/or the secondary sludge is contacted with a hydrolytic enzyme, to produce a supernatant that includes carbon sources.

14. The method of claim 13, wherein the wastewater is contacted with phosphorus consuming organisms and/or denitrifying organisms.

15. The method of any of claims 1 to 14, wherein the hydrolytic enzyme is added to the primary sludge and/or secondary sludge in an amount of 0.001%-15%, preferably 0.005%-10%, more preferably 0.01%-8%, most preferably 0.05%-5% of the total solids (TS) of the sludge by weight.

16. The method of any of claims 1 to 14, wherein the hydrolytic enzyme is selected from the group consisting of one or more cellulases, one or more lipases, one or more proteases, and one or more amylases and combinations thereof.

17. The method of any of claims 1 to 14, wherein the hydrolytic enzyme is selected from the group consisting of one or more cellulases, one or more hemicellulases, one or more lipases, one or more endo-proteases, and one or more amylases and combinations thereof.

18. The method according to any of claims 1 to 14, wherein the hydrolytic enzyme is selected from the group consisting of a xylanase, a cellulase, a hemicellulose, an amylase, a beta-glucosidase, an alpha galactosidase, a beta-galactosidase and a galactanase, a protease, a lipase, or combinations thereof.

19. The method according to any of claims 1 to 18, wherein the hydrolytic enzyme is contacted with primary or secondary sludge for 6 to 240 hours, such as 6 to 120 hours, typically 8 to 96 hours, such as 12 to 72 hours, more typically 18 to 72 hours.
